(19) United States
(12) Patent Application Publication
(10) Pub. No.: US 2015/0063640 A1
(43) Pub. Date: Mar. 5, 2015

(54) IMAGE PROCESSING APPARATUS AND IMAGE PROCESSING METHOD

(71) Applicant: CANON KABUSHIKI KAISHA, Tokyo (JP)

(72) Inventor: Mahoro Anabuki, Yokohama-shi (JP)

(21) Appl. No.: 14/469,265

(22) Filed: Aug. 26, 2014

(30) Foreign Application Priority Data
Aug. 28, 2013 (JP) 2013-176249

(51) Int. Cl. G06K 9/00; G06T 7/20

(52) U.S. Cl. CPC G06K 9/00536; G06T 7/20
USPC 382/103

(57) ABSTRACT

A person detection unit in an image processing apparatus is input an image captured by an image capturing unit and detects a person from the input image. An observation target determination unit determines an observation target in the image captured by the image capturing unit according to an action taken by the person detected by the person detection unit.

### BACKGROUND OF THE INVENTION

1. Field of the Invention

The present invention relates to a method for determining an observation area in an image.

2. Description of the Related Art

A system which automatically recognizes (gazes, tracks, identifies, and so on) a person, an object, and/or a spatial area appearing in an image captured by a camera using an image processing technique and records, distributes, and visualizes the recognized result is generally known (hereinbelow, referred to as a “monitoring system”). Such a monitoring system includes, for example, a room access management system having a personal identification function by a camera, a monitoring camera system for detecting presence or absence of a moving object in front of the camera, and a camera-equipped game system which uses a recognition result of a facial expression of a person and a position and posture of an object appearing in a camera image.

Recognition of a person, an object, and/or a spatial area by the monitoring system uses quite a number of computer resources (calculation time amounts, recording media, communication amounts, or the like). Therefore, when a lot of persons, objects, and spatial areas are included in an image captured by a camera, the computer resources to be required are too large, and a problem that the monitoring system cannot function practically (e.g., processing takes too long time, processing results cannot be recorded, and processing results cannot be transmitted) can occur.

In order to solve such a problem, the monitoring system uses techniques for determining a person, an object, and/or a spatial area to be particularly recognized (hereinbelow, referred to as an “observation target”) from among persons and objects which can be targets of the recognition processing and performing the recognition processing only on the observation target. The recognition processing discussed here includes gazing processing, tracking processing, identification processing and so on.

Japanese Patent Application Laid-Open No. 2001-111987 discusses a monitoring apparatus which automatically tracks only a person who is specified by a cursor among persons appearing in an image captured by a camera and encloses a display area of the specified person in a cursor area.

Japanese Patent Application Laid-Open No. 2006-101186 discusses a technique for, when a display unit of a captured image of a camera is touched, continuing to track a portion displayed in the touched part as an object.

However, according to these techniques, determination of an observation target in an image is sometimes inconvenient.

For example, when the technique discussed in Japanese Patent Application Laid-Open No. 2001-111987 or Japanese Patent Application Laid-Open No. 2006-101186 is used, there is a restriction that a person who can decide “what will be handled as an observation target” needs to be in a place where a camera image is displayed. Therefore, if an observation area is to be determined using the above-described techniques, it may cause some inconvenience.

### SUMMARY OF THE INVENTION

According to an aspect of the present invention, an image processing apparatus includes an obtaining unit configured to obtain an image, a detection unit configured to detect one or a plurality of persons from the obtained image, and a determination unit configured to determine an observation target according to a predetermined action taken by the detected person from an area different from an area corresponding to the person who takes the predetermined action.

Further features of the present invention will become apparent from the following description of exemplary embodiments with reference to the attached drawings.

### BRIEF DESCRIPTION OF THE DRAWINGS

FIG. 1 illustrates a configuration of a monitoring system including an image processing apparatus according to an exemplary embodiment.

FIG. 2 schematically illustrates an example of an image captured by an image capturing unit according to an exemplary embodiment.

FIG. 3 is a flowchart illustrating operations of an image processing apparatus according to an exemplary embodiment.

FIG. 4 illustrates a configuration of a monitoring system including an image processing apparatus according to an exemplary embodiment.

FIG. 5 schematically illustrates an example of an image captured by an image capturing unit according to an exemplary embodiment.

FIG. 6 is a flowchart illustrating operations of an image processing apparatus according to an exemplary embodiment.

FIG. 7 illustrates a configuration of a monitoring system including an image processing apparatus according to an exemplary embodiment.

FIG. 8 schematically illustrates an example of an image captured by an image capturing unit according to an exemplary embodiment.

FIG. 9 is a flowchart illustrating operations of an image processing apparatus according to an exemplary embodiment.

### DESCRIPTION OF THE EMBODIMENTS

Various exemplary embodiments, features, and aspects of the present invention will be described in detail below with reference to the drawings.

According to a first exemplary embodiment, an example is described in which a monitoring system is applied in a space where a large number of unspecified persons and a small number of specified persons who do some response to the large number of unspecified persons exist, such as a shop, a waiting room in a hospital or in a bank, and a ticket gate and a platform at a station. The monitoring system which includes an image capturing unit, an observation target recognition unit, a video display unit, and an image processing apparatus recognizes an observation target determined by the image processing apparatus through image processing, and captures and displays an image of the observation target.

### (Configuration)

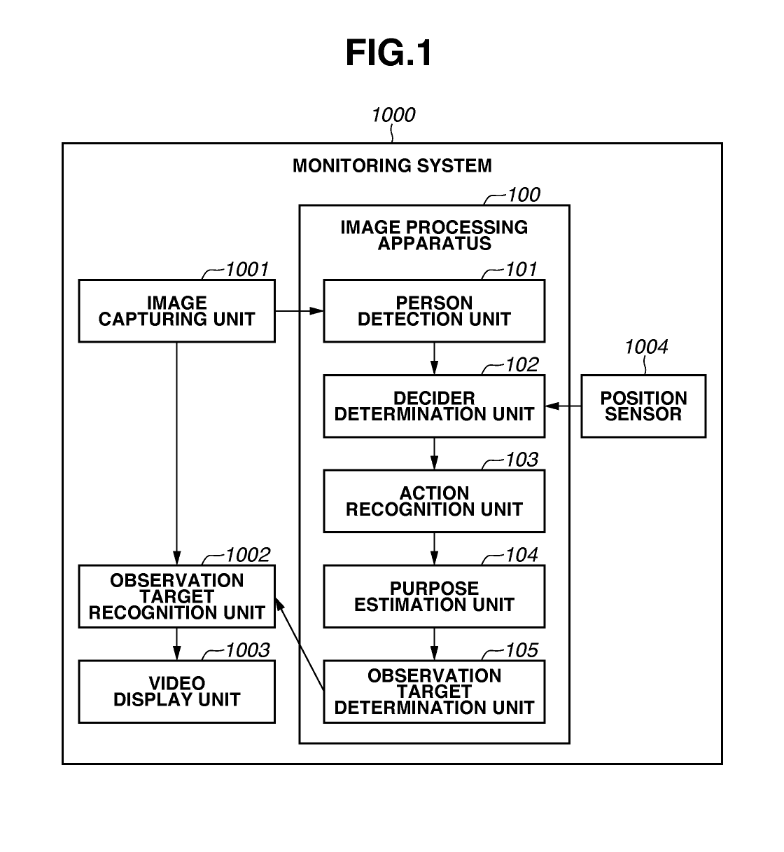

FIG. 1 illustrates a configuration of a monitoring system 1000 including an image processing apparatus 100 according to the present exemplary embodiment. The image processing apparatus 100 includes a person detection unit 101, a decider determination unit 102, an action recognition unit 103, a purpose estimation unit 104, and an observation target determination unit 105. The monitoring system 1000 further includes an image capturing unit 1001, an observation target recognition unit 1002, and a video display unit 1003 in addition to the image processing apparatus 100. The monitoring system 1000 may include a position sensor 1004. In addition, the image processing apparatus 100 may be integrated with any one or a plurality of the image capturing unit 1001, the observation target recognition unit 1002, and the video display unit 1003.

The image capturing unit 1001 is a camera for capturing an image of a space. The number of cameras may be one or plural. In addition, the image capturing unit 1001 may be a camera capturing visible light and a camera capturing light in an infrared range and an ultraviolet range. The image capturing unit 1001 continuously captures images when the monitoring system 1000 is running. According to the present exemplary embodiment, a space where the image capturing unit 1001 captures images is a shop. However, a space where the image capturing unit 1001 captures images is not limited to a shop, and may include a waiting room in a hospital or in a bank, a ticket gate and a platform at a station, and the like. The monitoring system according to the present exemplary embodiment is particularly suitable for a use case to be used in a space where a large number of unspecified persons and a small number of specified persons who do some response to the large number of unspecified persons exist.

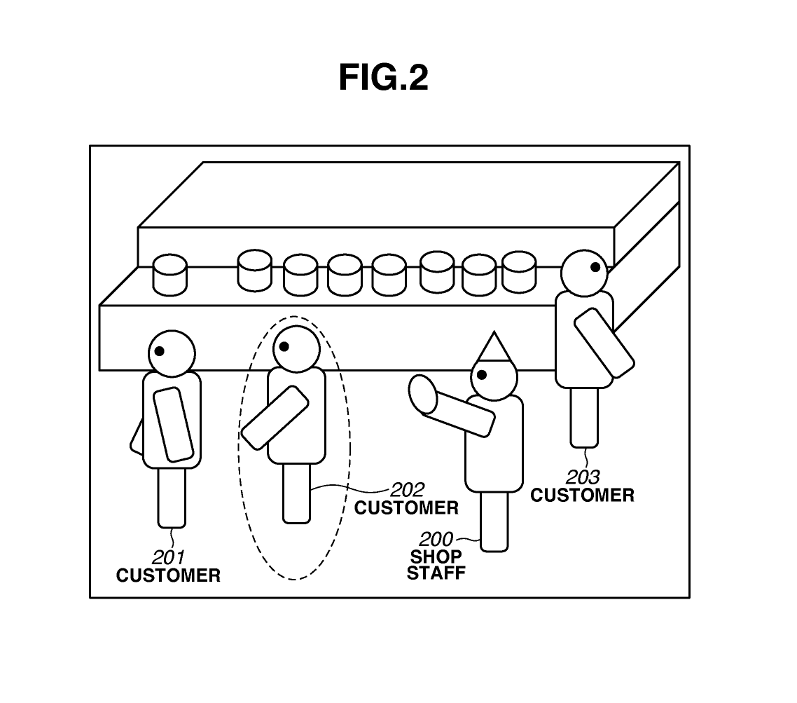

FIG. 2 schematically illustrates an example of an image captured by the image capturing unit 1001. FIG. 2 includes customers 201, 202, and 203 in a shop, who are regarded as a large number of unspecified persons appearing in the shop, and a shop staff 200 with a triangular cap serving the customers, who is regarded as a small number of specified persons appearing in the shop. The shop staff 200 indicates the customer 202 by the hand.

An image captured by the image capturing unit 1001 is transmitted to the person detection unit 101 and the observation target recognition unit 1002.

The person detection unit 101 inputs the image captured by the image capturing unit 1001 thereto and also detects a person in the captured image. Detection of a person can be realized by detecting image features regarding a person from an image captured by the image capturing unit 1001. As for the image features, a “histograms of oriented gradients” (HOG) feature amount can be used which is a feature amount obtained by converting a gradient direction in a local area to a histogram. The image feature regarding a person can be determined in such a manner that a large number of images including a person is collected, and objects common to feature amounts included in these images are statistically learned using, for example, an algorithm called Boosting. The person detection unit 101 determines that “a person is detected” when the image feature regarding a person is included in an image received from the image capturing unit 1001. In addition, the person detection unit 101 specifies an area in which a person is detected. Detection of a person can also be realized by dividing an image feature of a person into image features of human body parts, such as a “head” and “limbs”, and detecting each human body part.

In the example illustrated in FIG. 2, the shop staff 200 and the customers 201, 202, and 203 are detected by the person detection unit 101.

If a person is detected, the person detection unit 101 generates information for specifying an image area in which the person is detected and transmits the generated information to the decider determination unit 102 together with the image captured by the image capturing unit 1001. If a plurality of persons is detected from one image, the person detection unit 101 transmits information pieces each for specifying an image area of each detected person to the decider determination unit 102.

The decider determination unit 102 determines a person (decider) who decides an observation target from among the persons detected by the person detection unit 101. According to the present exemplary embodiment, a decider is a small number of specified persons (for example, a shop staff) who do some response to a large number of unspecified persons (for example, customers) appearing in a space where the image capturing unit 1001 captures images thereof. In FIG. 2, the shop staff 200 is a person (decider) who decides an observation target.

An observation target described here is a target to be particularly recognized from among persons, objects, and spatial areas included in an image captured by the image capturing unit 1001. The observation target recognition unit 1002 according to the present exemplary embodiment performs recognition processing on the target to be particularly recognized. Observation processing according to the present exemplary embodiment includes area extracting processing (gazing processing) for high resolution recording, processing for tracking a movement of the target, and identification processing of an individual of the target. The tracking processing may be performed by a combination of a plurality of cameras. If a target is a person, the recognition processing may be posture recognition, action recognition, or facial expression recognition of the person. The image processing apparatus 100 may be controlled not to record images captured by the image capturing unit 1001 in the normal operation and, when an observation target is determined, to record the captured image including the observation target.

Methods for determining a small number of specified deciders (i.e., the shop staff 200 according to the present exemplary embodiment) from among persons detected by the person detection unit 101 are described below.

A first method is to determine a decider from an image pattern of an area of a person. More specifically, the decider determination unit 102 first extracts portions including clothes and a face of a person from an area corresponding to the information for specifying the image area of the person which is transmitted from the person detection unit 101. Then, the decider determination unit 102 checks an extracted image pattern with image patterns stored in advance (for example, image patterns of a staff uniform and face images of the shop staffs) and determines a person with a higher coincidence degree as a decider. In the example illustrated in FIG. 2, a person wearing a triangular cap especially for a staff is extracted. The decider determination unit 102 can extract partial areas of clothes and a face of each person using a method for detecting human body parts of the person described in the detection method of a person by the person detection unit 101. Methods for identifying an image pattern and a face image are generally known, and thus the methods are not described in detail here.

As for another method for determining a decider, there is a method for determining a decider based on position information received from the position sensor 1004 provided outside of the image processing apparatus 100. The position sensor 1004 is a sensor held by a small number of specified persons (for example, a shop staff) and transmits position information to the decider determination unit 102. The decider determination unit 102 calculates which position a place indicated by the position information received from the position sensor 1004 corresponds to on the image captured by the image capturing unit 1001. Then, the decider determination unit 102 determines a person detected at (around) the position on the image as a decider.

As for a further different method for determining a decider, there is a method for determining a decider based on a length of time detected by the person detection unit 101. This method is based on an assumption that a person (a shop staff) who decides an observation target stays at (or around) a same place for a longer time compared with other large number of unspecified persons (customers) and is captured by the image capturing unit 1001 for a long time. More specifically, the decider determination unit 102 identifies each person using area information of the person received from the person detection unit 101. In other words, the decider determination unit 102 identifies each person in such a manner that a person detected at the same place or places very close to one another in temporally continuous images is the same person and a person other than that is a different person. Then, the decider determination unit 102 determines a person who is detected for a longest period of time among persons as a decider. In addition, the decider determination unit 102 may determine a person who is detected for the longest period of time among a plurality of persons and detected more than a predetermined period of time as a decider.

As a further different method for determining a decider, there is a method for manually selecting a decider. For example, a person standing in front of the video display unit 1003 on which images captured by the image capturing unit 1001 are displayed specifies a person in the image by performing a touch operation or a cursor operation on the video display unit 1003. Then, the position sensor 1004 measures a position on the specified captured image and transmits the measured value to the decider determination unit 102 as the position information. The decider determination unit 102 determines a person who is the nearest to a position corresponding to the position information received from the position sensor 1004 among persons detected by the person detection unit 101 as a decider.

However, methods for determining a decider are not limited to the methods described above. Further, the decider determination unit 102 can determine a decider by combining some of the above-described methods. For example, the decider determination unit 102 can determines a person detected for a longest period of time among persons who match a specific image pattern as a decider.

In addition, the decider determination unit 102 may determine only one person as a decider or a plurality of persons as deciders. Further, the decider determination unit 102 may not determine any person as a decider in some cases.

The decider determination unit 102 transmits information for specifying an image area of the determined decider and the image captured by the image capturing unit 1001 to the action recognition unit 103.

The action recognition unit 103 recognizes an action of the decider based on the captured image and the information for specifying the image area of the decider received from the decider determination unit 102. According to the present exemplary embodiment, recognition of the action is to obtain information indicating a change in postures (actions).

Therefore, the action recognition unit 103 first recognizes a posture of the person (the decider) based on the information for specifying the position of the decider received from the decider determination unit 102.

For example, the action recognition unit 103 receives the position information and posture information of the decider every human body part from the decider determination unit 102. The position information of the human body part is information for specifying a position of the human body part on the image. The posture information of the human body part is information for specifying an orientation of the human body part and the like. For example, in a case of facial parts, different posture information pieces are generated according to which direction a front side of a face including eyes and a nose is captured. The action recognition unit 103 recognizes the posture of the decider from, for example, a positional relationship among some human body parts, such as a head, limbs, and a body in the image and the posture information about the direction of the facial parts or the like.

The action recognition unit 103 further recognizes a temporal change in a posture recognition result. At this time, the action recognition unit 103 may recognize not a change in the posture through the body but a change in the posture of only some parts of the decider as the action thereof. For example, the posture change of only the facial parts (e.g., a change in the direction) may be recognized.

The recognition method of the posture change is not limited to the above-described methods and other known methods can be used.

Examples of the posture change (actions) recognized by the action recognition unit 103 include “raising one's hand”, “waving one's hand”, “making a bow”, “indicating by hand”, “looking at something for a certain period of time or more”, “turning one's palm”, “looking down”, “holding a something”, “walking (moving legs left and right)”, “sitting down”, and so on. A plurality of posture changes (actions) may be recognized in the same time. In other words, the action recognition unit 103 can recognize a posture change of “raising one's hand while walking”.

In the example illustrated in FIG. 2, a posture change of “indicating by hand” is recognized by the action recognition unit 103. More specifically, in the case that the action recognition unit 103 recognizes a state that the decider lowers his or her both hands as a posture thereof and then recognizes a state that the decider faces the hand forward for a certain period of time as a posture thereof, the action recognition unit 103 recognizes a posture change (action) of “indicating by hand”.

The action recognition unit 103 transmits information for specifying the action of the decider (for example, “indicating by hand”) and information regarding a positional relationship of the human body parts related to the action (for example, “information regarding a direction of the raised hand”) to the purpose estimation unit 104 as an action recognition result. Further, the action recognition unit 103 transmits the image captured by the image capturing unit 1001 to the purpose estimation unit 104.

The purpose estimation unit 104 estimates a purpose (or an intention) of the action of the decider using the action recognition result and the image captured by the image capturing unit 1001 received from the action recognition unit 103.

The estimation is realized by, for example, a supervised learning algorithm according to a machine learning. More specifically, the purpose estimation unit 104 generates in advance models for associating posture changes of the decider and a state of his or her surroundings with purposes causing the posture changes and statistically estimates what purpose caused each of the posture changes using the models. The information for specifying the posture change (action) of the decider is included in the action recognition result received from the action recognition unit 103. The purpose estimation unit 104 can obtain the state of the surroundings from the captured image received from the image capturing unit 1001. In addition, the state of the surroundings can be obtained by regarding an entire image captured by the image capturing unit 1001 as the surroundings or an image area within a certain range focusing on the decider as the surroundings. A size of the certain range can be changed according to a size of a decider in an image, for example.

The purpose estimation unit 104 according to the present exemplary embodiment estimates the purpose of the decider based on not only the posture change (action) of the decider but also the state of the surroundings, and thus the purpose estimation unit 104 can distinguish cases with different purposes from one another even if the posture changes (action) of the decider are exactly the same. In this regard, estimation processing performed by the purpose estimation unit 104 according to the present exemplary embodiment for estimating the purpose of the posture change of the decider is different from gesture recognition which interprets the purpose only from the posture change.

The purpose estimation unit 104 collects in advance groups in which the posture change of the decider and the state of the surroundings are associated with the purpose causing the posture change. The collection can be previously set by, for example, an administrator of the monitoring system 1000.

What kind of groups are specifically collected are different according to places to which the monitoring system 1000 is applied. There are merely examples, the purpose estimation unit 104 collects the tracking groups of <a posture change, a state of surroundings, and a purpose> to generates models.

More specifically, examples of groups to be collected are <raising one's hand, there is a person in the direction of his or her line of sight, and a greeting>, <waving one's hand, there is a person in the direction of his or her line of sight, and a greeting>, <making a bow, there is a person in the direction of the bow, and a greeting>, and <indicating by hand, there is a person, an object, or an aisle in the direction of the hand, and designation>.

Further, <looking at something for a certain period of time, there is a person or an object in the direction of his or her line of sight, and observation>, <turning one's palm, there is a person or an object in the direction of the palm, and designation>, and <looking down, there is an object in the direction of his or her line of sight, and an operation (packing, working on a cash register, doing bookkeeping, or the like)> are also examples of the groups to be collected.

Furthermore, <walking, there is an aisle in the direction of his or her line of sight, and a movement>, <sitting down, there is a chair or the like, stopping>, and <holding something, there is an object near his or her hand, conveyance> are other examples of the groups to be collected.

The action recognition unit 103 can determine that the posture change of “looking at something for a certain period of time” has occurred in the tracking case. More specifically, when the action recognition unit 103 determines that the decider does not look at the same direction for a certain period of time (a direction of the decider's face is not constant), and then determines that the decider looks at the same direction for a certain period of time, the action recognition unit 103 determines that the decider made the posture change of looking at something. In this case, the same direction has a predetermined range.

In addition, the action recognition unit 103 can determine that the decider made the posture change of looking at something in the case that, for example, the decider changes the direction of his or her face to look at the same area while moving. However, the determination method for the posture change of “looking at something for a certain period of time” is not limited to the above-described methods.

According to the present exemplary embodiment, groups of posture changes that a shop staff may make in the shop and their purposes are prepared in advance, and models for associating the posture change of the decider and the state of the surroundings with the purpose causing the posture change are generated therefrom.

The purpose estimation unit 104 estimates the purpose of the posture change indicated in the action recognition result based on the models generated as described above in advance using the action recognition result received from the action recognition unit 103 and the captured image received from the image capturing unit 1001.

If an estimation result of the purpose by the purpose estimation unit 104 is one of specific purposes determined in advance, the purpose estimation unit 104 transmits information (the action recognition result) received from the action recognition unit 103 and the image captured by the image capturing unit 1001 to the observation target determination unit 105.

The specific purposes described here are purposes for specifying an observation target. For example, a greeting, designation, and observation are examples of the specific purposes according to the present exemplary embodiment among the above-described purposes, such as a greeting, designation, observation, an operation, a movement, stopping, and conveyance.

For example, when the decider (i.e., a shop staff) of an observation target makes the posture change (action) of looking at something for a certain period of time or more, the purpose estimation unit 104 estimates that the purpose of the posture change of the decider is “observation”. Further, the purpose estimation unit 104 determines that the purpose (observation) of the decider's action is the specific purpose (the purpose for specifying the observation target) and transmits the information (the action recognition result) received from the action recognition unit 103 and the image captured by the image capturing unit 1001 to the observation target determination unit 105. In this regard, even if the decider (a shop staff) makes the posture change (action) of looking at something for a certain period of time or more, the purpose estimation unit 104 can estimate that the purpose of the posture change is not “observation” but a “break”, for example, in some cases depending on a state of the surroundings.

According to the present exemplary embodiment, the action recognition result includes the information for specifying the posture change of the decider (for example, “looking at something for a certain period of time or more”) and the information regarding the positional relationship of the human body parts related to the posture change (for example, information for specifying the direction of the decider's line of sight).

Further, for example, when the decider (a shop staff) of the observation target indicates some person, object, and/or spatial area by the finger or the hand, the purpose estimation unit 104 estimates that the purpose of the posture change of the decider is “designation”. Furthermore, the purpose estimation unit 104 estimates that the purpose of the action (designation) by the decider is the specific purpose (the purpose for specifying the observation target) and transmits the information (the action recognition result) received from the action recognition unit 103 and the image captured by the image capturing unit 1001 to the observation target determination unit 105. The action recognition result of this case includes the information for specifying the posture change of the decider (for example, pointing by the finger) and the information regarding the positional relationship of the human body parts related to the posture change (for example, information for specifying the direction of the finger and information for specifying the decider's line of sight at that time).

Further, for example, when the decider (a shop staff) of the observation target makes a bow to someone, the purpose estimation unit 104 estimates that the purpose of the posture change of the decider is a “greeting”. Furthermore, the purpose estimation unit 104 estimates that the purpose of the action (greeting) by the decider is the specific purpose (the purpose for specifying the observation target) and transmits the information (the action recognition result) received from the action recognition unit 103 and the image captured by the image capturing unit 1001 to the observation target determination unit 105. The action recognition result of this case includes the information for specifying the posture change of the decider (for example, making a bow) and the information regarding the positional relationship of the human body parts related to the posture change (for example, a direction of the bow). In addition, information for specifying how deep the bow is made, a time length of the bow, and so on can be included in the information about the action recognition result.

According to the present exemplary embodiment, a purpose of an action (a posture change) having some object can be determined as the specific purpose. In other words, the purpose estimation unit 104 according to the present exemplary embodiment can estimate that a purpose of a posture change, such as “observation” of something, “designation” of something, a “greeting” to someone, an “operation” performed on something, or “conveyance” of something is the specific purpose. However, not every purpose of a posture change having some purpose is estimated as the specific purpose.

On the other hand, according to the present exemplary embodiment, a purpose of a posture change having no object (for example, a “movement” and “stopping”) is not estimated as the specific purpose. As for a case of proceeding toward a certain direction, if the “certain direction” does not have special meaning, it is estimated that the posture change has no object.

FIG. 2 illustrates a case when the posture change of the shop staff 200 who is the decider of the observation target is recognized as “indicating by hand” by the action recognition unit 103, the customer 202 is displayed in the surroundings of the decider, and, as a result, the purpose estimation unit 104 estimates that the purpose is “designation”. In the example illustrated in FIG. 2, the purpose, “designation”, is determined as one of the specific purposes in advance.

In some cases, a posture change of the decider of the observation target may be composite one, such as waving one's hand while walking. In such a case, the purpose can be both of “movement” and “greeting”. If the “greeting” is included in the specific purposes determined in advance, the purpose estimation unit 104 determines that the purpose of the decider matches with the specific purpose and transmits the information (the action recognition result and the image captured by the image capturing unit 1001) received from the action recognition unit 103 to the observation target determination unit 105.

When receiving the action recognition result and the image captured by the image capturing unit 1001 from the purpose estimation unit 104, the observation target determination unit 105 determines an observation target from among persons, objects, and areas appearing in the image captured by the image capturing unit 1001. More specifically, the observation target determination unit 105 specifies where a target of the posture change (action) recognized by the action recognition unit 103 is displayed in the image captured by the image capturing unit 1001.

Therefore, the observation target determination unit 105 first determines which direction in the captured image the posture change recognized by the action recognition unit 103 is made. The direction is determined by the positional relationships among the human body parts of the decider as an agent of the action and orientations of the human body parts themselves.

For example, when the recognized posture change is “looking at something for a certain period of time or more”, an orientation of the facial parts, in other words, a direction of eyes in the facial parts is the direction to which the posture change is directed.

For example, when the recognized posture change is “turning one's palm”, a direction to which palm parts face is the direction to which the posture change is detected. For example, when the recognized posture change is “indicating by hand”, a direction from body parts to arm parts is the direction to which the posture change is directed to. The positional relationships among the human body parts of the decider of the observation target and orientations of the human body parts themselves are included in the action recognition result recognized by the action recognition unit 103 which is received from the purpose estimation unit 104.

Then, a person, an object, or a spatial area in the direction to which the posture change is directed recognized by the action recognition unit 103 is detected. For example, the observation target determination unit 105 detects a person and an object existing near a straight line from a position on which the decider is extracted to the direction to which the recognized posture change is directed in the image captured by the image capturing unit 1001 in order from the one closest to the decider of the observation target. Since publicly known methods can be applied to the detection method of a person and an object, the descriptions thereof are omitted.

The observation target determination unit 105 regards the person, the object, or the spatial area which is found as described above as a target of the posture change recognized by the action recognition unit 103.

In the example illustrated in FIG. 2, the shop staff 200 makes the posture change of “indicating by hand”, and thus the customer 202 who is displayed in the direction indicated by the arm parts of the shop staff 200 is regarded as the target of the posture change recognized by the action recognition unit 103.

In this regards, a plurality of targets of the recognized posture changes may be identified. In the example illustrated in FIG. 2, not only the customer 202 but also the customer 201 displayed ahead of the customer 202 can be the target of the posture change recognized by the action recognition unit 103.

If the observation target is determined, information indicating a position of the observation target on the image captured by the image capturing unit 1001 is transmitted to the observation target recognition unit 1002.

In addition, the observation target determination unit 105 can change an image capturing direction of the image capturing unit 1001 to the direction to which the posture change of the decider is directed to detect a person, an object, or an area to be a target of the posture change of the decider. In this case, the observation target determination unit 105 can control the image capturing direction of the image capturing unit 1001 by transmitting an instruction, such as panning, tilting, and zooming to the image capturing unit 1001. Performing such operations enables the observation target determination unit 105 to determine a person, an object, and so on, which are not included in an image capturing range of the image capturing unit 1001 when the decider makes the posture change with the specific purpose, as an observation target.

Once the observation target determination unit 105 determines the observation target, the observation target determination unit 105 continues to determine the same target as the observation target until a new action recognition result is received. Therefore, the observation target determination unit 105 according to the present exemplary embodiment stores information for identifying the observation target therein.

The information for identifying the observation target includes the information indicating the position of the observation target on the captured image and feature amounts regarding an appearance of the observation target, such as a color and a shape. The observation target determination unit 105 updates the information indicating the position of the observation target each time the observation target is determined (every predetermined period of time). More specifically, the observation target determination unit 105 determines a position of the observation target from a captured image (a first captured image) of the image capturing unit 1001 and then, when a next captured image (a second captured image) is obtained, detects the observation target from the second captured image. If the position of the observation target in the first captured image is somewhat different from the position of the observation target in the second captured image by the movement of the observation target, the observation target determination unit 105 can detect the observation target in the second captured image using the information about the feature amount of the observation target. Further, when determining the observation target from the second captured image, the observation target determination unit 105 stores the position of the observation target in the second captured image and the feature amount of the observation target and uses them to detect the observation target in a next third captured image.

If the observation target determination unit 105 does not receive a new action recognition result from the purpose estimation unit 104, the observation target determination unit 105 specifies a position of the observation target in the next captured image and stores the current position of the observation target and the feature amount of the observation target within the image processing apparatus 100. The observation target determination unit 105 obtains images captured every predetermined time period by the image capturing unit 1001. The observation target determination unit 105 may obtain all images or, for example, one flame per second of an image captured by the image capturing unit 1001.

Further, the observation target determination unit 105 does not have to obtain an image captured by the image capturing unit 1001 in the case that an observation target is not yet determined and no person is detected by the person detection unit 101. The observation target determination unit 105 also transmits the position information of the observation target to the observation target recognition unit 1002.

In the above descriptions, the example is described focusing on that the observation target is not changed until the observation target determination unit 105 obtains a new action recognition result. However, the present exemplary embodiment is not limited to this example. In other words, when a predetermined period of time has elapsed after the determination of the observation target or when the observation target is no longer recognized in the captured image, the observation target determination unit 105 may perform processing to stop the observation processing with respect to the observation target. Further, when a new action recognition result is received, the observation target determination unit 105 may regard an observation target specified from the newly received action recognition result as the observation target in addition to the previous observation target.

In other words, the observation target determination unit 105 can determine a plurality of persons, objects, and areas as the observation targets. Further, when an action recognition result is newly received after determining the observation target, the observation target determination unit 105 can add the observation target thereto. Furthermore, when a predetermined action recognition result is newly received after determining the observation target, the observation target determination unit 105 can exclude the already determined observation target from the observation target.

The observation target recognition unit 1002 performs observation processing with respect to the captured image received from the image capturing unit 1001. The observation processing targets on a person, an object, and a spatial area which are displayed on a position in the captured image indicated by information received from the observation target determination unit 105.

The observation target recognition unit 1002 according to the present exemplary embodiment can perform processing (tracking processing) for tracking a position of an observation target in a captured image as observation processing of the observation target. The tracking processing may be performed by a combination of a plurality of cameras. In addition, the observation target recognition unit 1002 can perform, as the observation processing, identification processing of the observation target. The identification processing is processing for identifying a posture (for example, squatting and lying) of an observation target, when the observation target is a person. The observation target recognition unit 1002 can also identify age, sex, individual, and facial expression of an observation target person, as the identification processing.

The observation target recognition unit 1002 can also identify, when the observation target is an object, a state of the object, such as the observation target object is dropped, the observation target object is thrown by somebody, and the observation target object disappears without crossing an edge of the captured image (for example, the observation target object is dropped into a pocket), as the identification processing.

Further, the observation target recognition unit 1002 can perform processing (gazing processing) for extracting an area for high resolution recording, as the observation processing with respect to the observation target. In this case, the observation target recognition unit 1002 can control an optical zoom magnification of the image capturing unit 1001 so that an area of the observation target object is displayed larger and extract an image of which resolution is higher than the one before the observation target is determined. In this regard, the observation target recognition unit 1002 can control recording so as to record an image at resolution higher than normal recording instead of controlling the optical zoom magnification. Further, the observation target recognition unit 1002 can control an image capturing unit, which performs image capturing in a narrow range, to capture an image in the narrow range of an observation target which is determined from an image captured by the image capturing unit 1001 which performs image capturing in a wide range.

For example, in a case of a monitoring system aimed at preventing shoplifting, the observation target recognition unit 1002 can recognize a posture change, such as a person as an observation target stealing an item on a store shelf into his or her pocket by the observation processing. In a case of a monitoring system aimed at evaluating a degree of potential excellent customer, the observation target recognition unit 1002 can quantitatively evaluate how much a person as an observation target has a willingness to buy from his or her facial expression. Contents of the observation processing performed by the observation target recognition unit 1002 are not limited to the above-described ones.

The observation target recognition unit 1002 according to the present exemplary embodiment can perform different observation processing according to a purpose of a posture change (action) of a decider of an observation target. For example, when the decider greets someone, the observation target recognition unit 1002 can recognize a facial expression of the person who is greeted, and when the decider points a finger at someone, the observation target recognition unit 1002 can track the person who is pointed. In this case, the observation target determination unit 105 transmits the position information of the observation target person together with the action recognition result (the information for specifying the action of the decider and the information regarding the positional relationship of the human body parts related to the action) by the action recognition unit 103 to the observation target recognition unit 1002. Then, the observation target determination unit 105 determines the observation processing with respect to the observation target person based on the contents of the action recognized by the action recognition unit 103.

The recognition result of the observation target recognition unit 1002 and the information indicating the position on the image on which the recognition is made are transmitted to the video display unit 1003 together with the captured image received from the image capturing unit 1001.

The video display unit 1003 receives the image captured by the image capturing unit 1001 from the observation target recognition unit 1002 and displays the received image. The video display unit 1003 also receives the recognition result and the information indicating the position on the image on which the recognition is made from the observation target recognition unit 1002 and visualizes and displays the received information.

For example, the video display unit 1003 superimposes the display indicating the recognition result received from the observation target recognition unit 1002 on the image captured by the image capturing unit 1001. In FIG. 2, the customer 202 is encircled in a dotted line. This is an example visualizing that the customer 202 is determined as the observation target by the observation target determination unit 105, and the observation processing is performed by the observation target recognition unit 1002.

The visualization method is not limited to the above-described examples. For example, the video display unit 1003 may display a text or an icon indicating the recognition result by the observation target recognition unit 1002 and an area of the captured image in which the recognition result is obtained by extracting the area in an area different from a display area of the captured image received from the image capturing unit 1001.

Since the video display unit 1003 displays the recognition result of the observation target recognition unit 1002, a user can easily confirm that which target is set as the observation target by the image processing apparatus 100.

### (Processing)

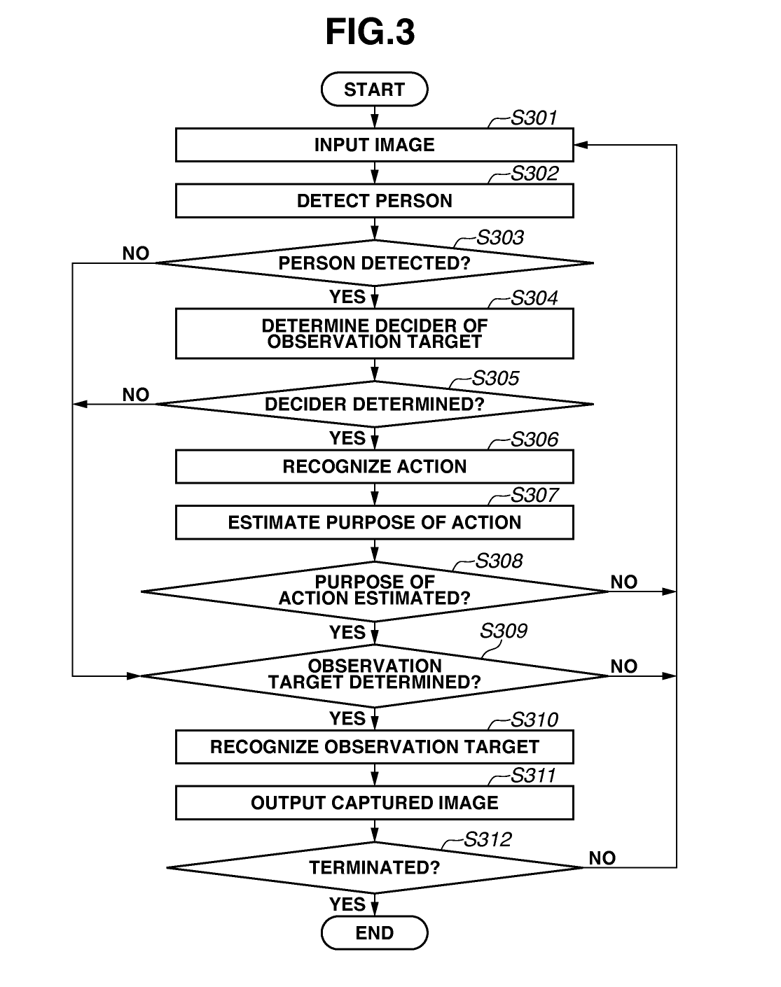

Next, processing performed by the monitoring system 1000 including the image processing apparatus 100 according to the present exemplary embodiment is described using a flowchart illustrated in FIG. 3. A central processing unit (CPU), which is not illustrated, reads out a program for executing the processing in FIG. 3 to a memory and executes the program, so that the image processing apparatus 100 according to the present exemplary embodiment can realize the processing illustrated in FIG. 3. Further, the image capturing unit 1001, the observation target recognition unit 1002, and the video display unit 1003 respectively includes CPUs, and each of the CPUs executes a program necessary for the respective apparatuses. However, a configuration of apparatuses in the monitoring system can be changed accordingly, for example, the observation target recognition unit 1002 and the video display unit 1003 are configured as an integrated apparatus, and processing performed in the observation target recognition unit 1002 and the video display unit 1003 are realized by the same CPU.

If a user starts up the monitoring system 1000 in a state that the image capturing unit 1001 is disposed in a space in a shop or the like, first, the processing in step S301 is performed.

In step S301 (an input procedure), the image capturing unit 1001 performs image capturing. If the image capturing unit 1001 includes a plurality of cameras, the plurality of cameras performs image capturing. All captured images are transmitted to the person detection unit 101 and the observation target recognition unit 1002. According to the present exemplary embodiment, an example in which all images captured by the image capturing unit 1001 are transmitted to the person detection unit 101 is mainly described, however, a frame rate of a captured image to be transmitted to the person detection unit 101 may be lower than a frame rate of the image capturing. For example, when the image capturing unit 1001 performs image capturing at 30 frames per second, a captured image with every other frame, namely 15 frames per second may be transmitted to the person detection unit 101. If the person detection unit 101 is input the captured image from the image capturing unit 1001, the processing proceeds to step S302.

In step S302 (a detection procedure), the person detection unit 101 performs processing for detecting an area in which a person is captured in the image received from the image capturing unit 1001. When the person detection unit 101 finishes the person detection processing, the processing proceeds to step S303.

In step S303, it is confirmed whether the person detection unit 101 detects a person in the image received from the image capturing unit 1001. If a person is not detected (NO in step S303), the processing proceeds to step S309. If a person is detected (YES in step S303), the person detection unit 101 generates information for specifying an image area in which the person is detected and transmits the information to the decider determination unit 102 together with the image captured by the image capturing unit 1001. If a plurality of persons is detected, the person detection unit 101 generates information pieces each for specifying an image area of each detected person and transmits the information pieces to the decider determination unit 102. If the person detection unit 101 transmits the information for specifying the position of the person to the decider determination unit 102, the processing proceeds to step S304.

In step S304, the decider determination unit 102 determines a person (a decider) who decides an observation target. The decider determination unit 102 according to the present exemplary embodiment determines a small number of specified persons (a shop staff) who do some response to a large number of unspecified persons (customers) existing in the image captured by the image capturing unit 1001 as the decider. In FIG. 2, the shop staff 200 is determined as the decider.

As for a method for determining a small number of specific persons (the shop staff 200 according to the present exemplary embodiment) from persons detected by the person detection unit 101, there is a method for determining based on an image pattern (an image pattern of clothes and/or a face) of a person in the image captured by the image capturing unit 1001. In addition to that, a method for determining the decider of the observation target based on an output received from the position sensor 1004 externally provided to the image processing apparatus 100 which is held by the small number of specified persons or a method for determining based on a time length detected by the person detection unit 101 can be used. A third person may manually select the decider of the observation target. When the processing for determining the decider of the observation target is finished, the processing proceeds to step S305.

In step S305, it is confirmed whether the decider determination unit 102 determines the decider of the observation target from among the persons detected by the person detection unit 101. If the decider is not determined (NO in step S305), the processing proceeds to step S309. If the decider is determined (YES in step S305), the decider determination unit 102 transmits the position information for specifying an image area of the decider and the captured image to the action recognition unit 103. Then, the processing proceeds to step S306.

In step S306, the action recognition unit 103 receives the position information of the decider together with the image captured by the image capturing unit 1001 and recognizes a posture change (action) of the decider. According to the present exemplary embodiment, an action can be restated as a motion.

Therefore, the action recognition unit 103 first recognizes a posture of the decider based on the position information for specifying the image area of the decider received from the decider determination unit 102. Then, the action recognition unit 103 receives a new captured image from the image capturing unit 1001, detects the decider of the observation target captured in the newly received image, and recognizes a posture of the decider. A series of posture recognition results obtained by repeating the posture recognition processing for a fixed number of times is information indicating the posture change. The information indicating the posture change which is thus obtained is transmitted by the action recognition unit 103 as the action recognition result to the purpose estimation unit 104. Then, the processing proceeds to step S307.

In step S307, the purpose estimation unit 104 estimates an action taken by the decider of the observation target, namely a purpose (or an intention) of the posture change based on the action recognition result and the image captured by the image capturing unit 1001 received from the action recognition unit 103. This estimation is realized by, for example, the supervised learning algorithm according to the machine learning. In other words, the purpose estimation unit 104 uses a model for associating the posture change of the decider of the observation target and a state of his or her surroundings with the purpose of the posture change to estimate the purpose of the posture change of the decider. The model is generated in advance. If the estimation processing is performed, the processing proceeds to step S308.

In step S308, it is determined whether the purpose of the posture change of the decider estimated by the purpose estimation unit 104 is the specific purpose. The specific purpose according to the present exemplary embodiment is a purpose for specifying an observation target. According to the present exemplary embodiment, among purposes, such as a greeting, designation, observation, an operation, a movement, stopping, and conveyance, it is determined that a greeting, designation, and observation match with the specific purposes (purposes for specifying the observation target). However, the specific purpose is not limited to the above-described examples. If it is determined that the estimated purpose matches with the specific purpose (YES in step S308), the purpose estimation unit 104 transmits the action recognition result and the image captured by the image capturing unit 1001 received from the action recognition unit 103 to the observation target determination unit 105, and the processing proceeds to step S309. The action recognition result includes the information for specifying the posture change of the decider (for example, “pointing a finger at an object”) and the information regarding the positional relationship of the human body parts related to the posture change (for example, a direction of the finger).

On the other hand, if it is determined that the purpose estimated by the action recognition unit 103 does not match the specific purpose (NO in step S308), the processing returns to step S301.

The action recognition unit 103 may transmit not only the action recognition result and the image captured by the image capturing unit 1001 but also information for specifying a purpose of the action (for example, “greeting” and “designation”) to the observation target determination unit 105. According to such processing, the observation target recognition unit 1002 can perform different observation processing with respect to the observation target according to the purpose of the action of the decider. Further, the observation target determination unit 105 can determine a target (a person, an object, an area, and so on) according to the purpose of the action of the decider as the observation target.

In step S309 (a determination procedure), the observation target determination unit 105 determines the observation target from among persons, objects, and areas in the image captured by the image capturing unit 1001. In other words, the observation target determination unit 105 determines, according to a predetermined action taken by a person detected by the person detection unit 101, a person other than the person who takes the predetermined action as the observation target. In the example illustrated in FIG. 2, when the decider (the shop staff 200) points a finger at someone, the customer 202 existing in the direction pointed by the finger is determined as the observation target. The observation target is not limited to a person, and may be an object and an area.

As for the methods for determining the decider, there are a method for determining based on an appearance of a person (a feature amount of an image pattern), a method for determining based on information received from the position sensor 1004, and a method for determining based on a length of time in which the decider is detected by the person detection unit 101.

More specifically, when the decider is determined based on his or her appearance (a feature amount of an image pattern), the observation target determination unit 105 determines an observation target according to an action (a posture change) of a person (the decider) having a predetermined feature amount among persons detected by the person detection unit 101.

Further, when the decider is determined based on the information received from the position sensor 1004, the observation target determination unit 105 determines an observation target according to an action (a posture change) of a person (the decider) corresponding to the information from the position sensor among persons detected by the person detection unit 101.

Furthermore, when the decider is determined based on a length of time in which the decider is detected by the person detection unit 101, the observation target determination unit 105 determines an observation target according to an action of a person (the decider) who exists in the captured image for a predetermined length of time or more among persons detected by the person detection unit 101.

When the processing proceeds from step S308 to step S309, the observation target determination unit 105 receives the action recognition result recognized by the action recognition unit 103 and the image captured by the image capturing unit 1001. The observation target determination unit 105 determines the observation target using these information pieces. For example, if it is estimated that a person is indicated by hand, the person indicated by hand is determined as the observation target.

More specifically, the observation target determination unit 105 specifies where the target of the posture change recognized by the action recognition unit 103 exists in the image captured by the image capturing unit 1001. If the observation target can be determined (YES in step S309), the observation target determination unit 105 stores information for specifying the observation target (observation target specification information) therein, and then the processing proceeds to step S310. If the observation target cannot be determined (NO in step S309), the processing returns to step S301. The observation target specification information according to the present exemplary embodiment includes the information indicating the position of the observation target on the captured image and the feature amount regarding the appearance of the observation target, such as color and shape.

When the processing proceeds from step S303 or step S305 to step S309, it is confirmed whether the observation target determination unit 105 stores the observation target specification information therein. If it is confirmed that the observation target specification information is stored within the observation target determination unit 105, the observation target determination unit 105 transmits the information indicating the position of the observation target, which is a part of the observation target specification information, to the observation target recognition unit 1002, and then the processing proceeds to step S310. If the observation target specification information is not stored within the observation target determination unit 105, the processing returns to step S301.

In step S310, the observation target recognition unit 1002 performs the observation processing on the observation target. More specifically, the observation target recognition unit 1002 obtains from the observation target determination unit 105 the information regarding the position of the person, the object, or the spatial area as the observation target on the captured image and performs the observation processing on the observation target. The observation processing includes, for example, the tracking processing with respect to the observation target, identification processing of the observation target (the identification processing for a posture, a posture change, and a facial expression of the person), and extracting processing of a high resolution image.

The observation target recognition unit 1002 can determine which observation processing is performed on the observation target according to whether the observation target is a person, an object, or an area. The observation target recognition unit 1002 can also determine which observation processing is performed on the observation target based on the posture change (action) made by the decider of the observation target. Further, the observation target recognition unit 1002 can determine which observation processing is performed on the observation target based on the estimation result of the purpose of the posture change (action) made by the decider of the observation target. Furthermore, the observation target recognition unit 1002 can determine the contents of the observation processing performed on the observation target by combining the above-described methods.

For example, when the decider points a finger at a someone, the observation target recognition unit 1002 may perform the tracking processing with respect to the person, and when the decider greets someone, the observation target recognition unit 1002 may perform the processing for recognizing a facial expression of the person. Further, the observation target recognition unit 1002 may be configured to, for example, when the decider points a finger at a person, perform the processing for recognizing a facial expression of the person, and when the decider points a finger at an object, perform the tracking processing with respect to the object.

If the observation target recognition unit 1002 performs the observation processing on the observation target and transmits the information regarding the position of the observation target, information indicating a result of the observation processing, and the image captured by the image capturing unit 1001 to the video display unit 1003. Then, the processing proceeds to step S311.

In step S311, the video display unit 1003 receives the image captured by the image capturing unit 1001 from the observation target recognition unit 1002 and displays the received image. The video display unit 1003 also receives the information regarding the position of the observation target and the information indicating the result of the observation processing from the observation target recognition unit 1002 and performs display corresponding to the received information pieces.

The video display unit 1003 may display a dotted line encircling the observation target therein or superimpose an arrow pointing the observation target on the captured image, for example. However, not limited to the display described above, the video display unit 1003 can perform display for emphasizing the observation target so as to enable a user who views the captured image to easily specify the observation target. Further, the video display unit 1003 can display observation results of the observation target (for example, a time length that the observation target person stayed in the image, a recognition result of the facial expression, and a recognition result of the posture change) by a text, an icon, or the like in an area different from the display area of the image captured by the image capturing unit 1001. When the video display unit 1003 finishes the display, the processing proceeds to step S312. In step S312, it is confirmed whether the processing of the monitoring system 1000 will be terminated or not. If no, the processing returns to step S301. If yes, the processing is terminated.

According to the above-described processing, the image processing apparatus 100 can set, based on a posture change (action) having a specific purpose made by a specific person (i.e., a decider of an observation target) existing in an image captured by the image capturing unit 1001, a person, an object, or a spatial area which is a target of the posture change as a target of observation processing. In the example according to the present exemplary embodiment, if a shop staff makes a specific posture change, one or a plurality of customers visiting the shop can be set as a recognition target of a suspicious action, such as shoplifting, or an evaluation target of a degree of potential excellent customer. In other words, the image processing apparatus 100 can set a person who is indicated by hand or looked at for a certain period of time by the shop staff as an observation target to be particularly recognized. The observation target is not limited to a person, and an object such as an item sold in the shop and a specific area in an aisle may be the observation target. In that case, the observation target recognition unit 1002 can regard the object set as the observation target as a target of leaving detection or a target of conveyance route recognition. If an action natural in the circumstances, such as looking at something for a certain period of time is set as a specific action for setting an observation target, the observation target can be set without being noticed by persons in the surroundings including a customer to be regarded as the observation target.

In the above descriptions of the present exemplary embodiment, the observation target recognition unit 1002 is described to perform the observation processing targeting on a person, an object, and a spatial area existing on a position in a captured image indicated by the observation target determination unit 105. On the contrary, a person and an object indicated by the observation target determination unit 105 may be excluded from a target of the observation processing.

For example, when a person, an object, or a spatial area which is already regarded as the observation target by the observation target recognition unit 1002 is indicated by the observation target determination unit 105, the observation target recognition unit 1002 may exclude the person, the object, or the spatial area from the observation target. In other words, the setting of the observation target can be canceled using the image processing apparatus 100 according to the present exemplary embodiment.

Similarly, the observation target recognition unit 1002 may perform the recognition processing targeting on a person, an object, and a spatial area other than the ones indicated by the observation target determination unit 105. In other words, instead of setting a person, an object, and a spatial area which are particularly observed to the image processing apparatus 100, a person, an object, and a spatial area which do not need to be particularly observed can be set by the image processing apparatus 100.

According to a second exemplary embodiment, an example is described in which a monitoring system is applied in a space where a large number of unspecified persons come and go, such as an aisle in a shopping mall, and a platform and a concourse of a station. The monitoring system according to the present exemplary embodiment which includes an image capturing unit, an observation target recognition unit, a video display unit, and an image processing apparatus recognizes an observation target determined by the image processing apparatus through image processing, and captures and displays an image of the observation target.

### (Configuration)

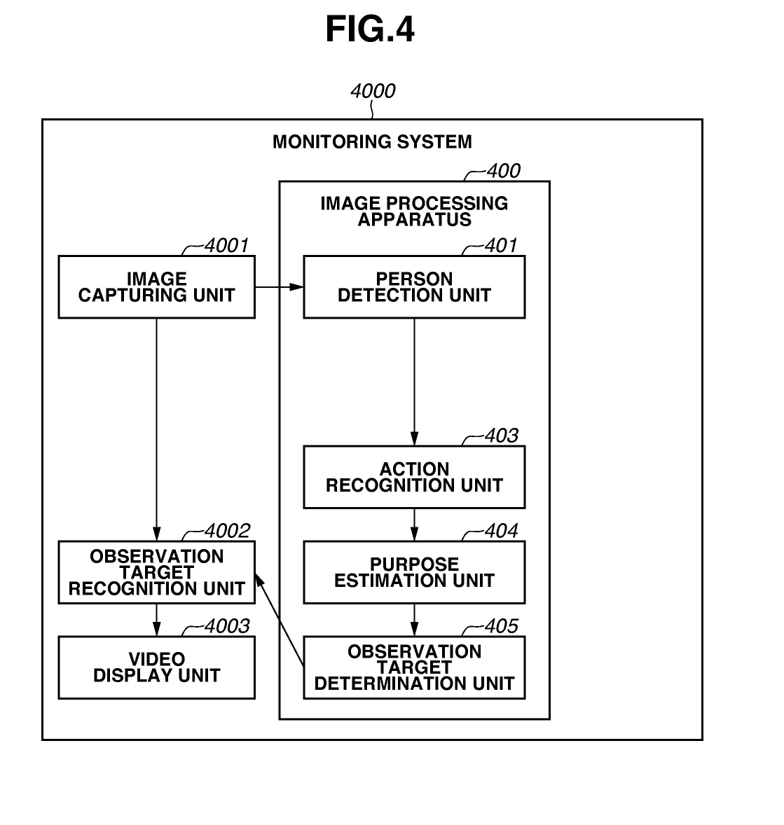

FIG. 4 illustrates a configuration of a monitoring system 4000 including an image processing apparatus 400 according to the present exemplary embodiment. More specifically, the image processing apparatus 400 includes a person detection unit 401, an action recognition unit 403, a purpose estimation unit 404, and an observation target determination unit 405. The monitoring system 4000 further includes an image capturing unit 4001, an observation target recognition unit 4002, a video display unit 4003, and the image processing apparatus 400. In addition, the image processing apparatus 400 may be integrated with any one or a plurality of the image capturing unit 4001, the observation target recognition unit 4002, and the video display unit 4003.

The image capturing unit 4001 is a camera for capturing an image of a space. The number of cameras may be one or plural. In addition, the image capturing unit 4001 may be a camera capturing visible light and a camera capturing light in an infrared range and an ultraviolet range. The image capturing unit 4001 continuously captures images when the monitoring system 4000 is running. According to the present exemplary embodiment, a space where the image capturing unit 4001 captures images is a concourse of a station. However, a space where the image capturing unit 4001 captures images is not limited to a concourse of a station, and can be an aisle in a shopping mall, a platform of a station, and the like. The monitoring system according to the present exemplary embodiment is particularly suitable for a use case to be used in a space where a large number of unspecified persons come and go.

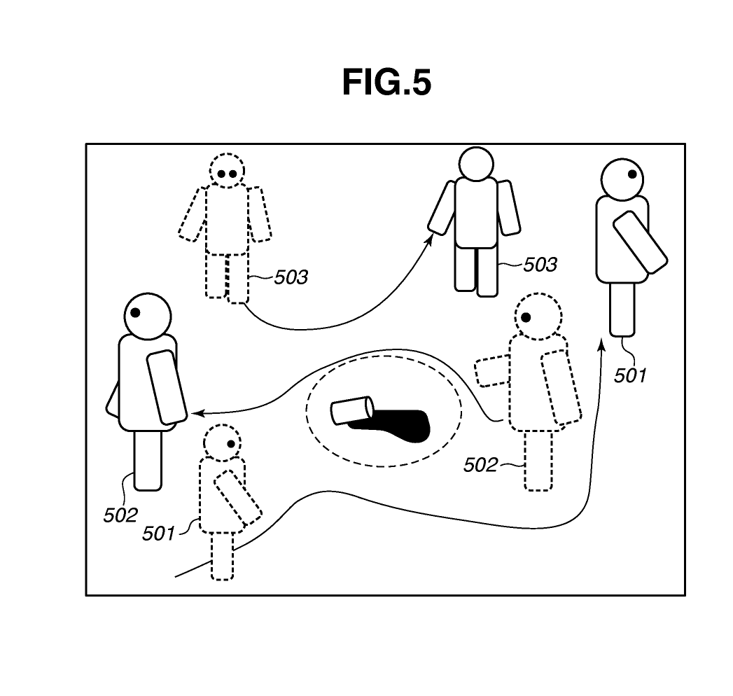

FIG. 5 schematically illustrates an example of an image captured by the image capturing unit 4001. FIG. 5 includes passersby 501, 502, and 503, who are regarded as a large number of unspecified persons come and go a concourse of a station. In addition, juice spilt from a fallen bottle is shown near the middle of an image capturing range. Curved arrows in FIG. 5 respectively indicate moving paths of the passersby 501, 502, and 503. In other words, FIG. 5 indicates that each of the passersby moved from positions of the passersby 501, 502, and 503 drawn by dotted lines to positions of the passersby 501, 502, and 503 drawn by solid lines along the curved arrows.

Such an image captured by the image capturing unit 4001 is transmitted to the person detection unit 401 and the observation target recognition unit 4002.

The person detection unit 401 receives the image captured by the image capturing unit 4001 and detects a person from the captured image. Detection of a person can be realized by detecting image features regarding a person from an image captured by the image capturing unit 4001. A method for detecting a person is similar to the person detection method performed by the person detection unit 101 according to the first exemplary embodiment, and thus detail descriptions thereof are omitted. In the example illustrated in FIG. 5, the passersby 501, 502, and 503 are detected.

If a person is detected, the person detection unit 401 generates information for specifying an image area in which the person is detected and transmits the generated information to the action recognition unit 403 together with the image captured by the image capturing unit 4001. If a plurality of persons is detected from one image, the person detection unit 401 transmits information pieces each for specifying an image area of each detected person to the action recognition unit 403.

The action recognition unit 403 recognizes an action of persons as a group using the information for specifying the image area in which the person is detected which is received from the person detection unit 401. According to the present exemplary embodiment, recognition of an action as a group is to obtain information regarding movements of all detected persons.

Therefore, the action recognition unit 403 first generates person detection distribution on the image captured by the image capturing unit 4001 and stores the person detection distribution therein. The person detection distribution is information indicating that how many persons are detected in each of predetermined divided areas in a captured image. The person detection distribution is information indicating how many persons are detected in each of divided areas, for example, when a captured image is divided into nine by nine areas. However, a division size is not limited to nine by nine.

Every time information for specifying an image area in which a person is detected is obtained from the person detection unit 401, the action recognition unit 403 performs generation and storage of the person detection distribution. In addition, the action recognition unit 403 generates information indicating a temporal change in the person detection distribution by comparing the person detection distribution accumulated in the past with the latest person detection distribution. The latest person detection distribution and the information indicating the temporal change in the person detection distribution thus generated are the information regarding movements of all detected persons

In other words, the action recognition unit 403 obtains the number of persons who are detected in each of divided areas in the captured image at every predetermined time. The predetermined time may be a time corresponding to a frame rate of image capturing by the image capturing unit 4001 (For example, 1/30 second in a case of the frame rate of 30 frames per second), or may be a time longer than that.

Further, the action recognition unit 403 obtains a temporal change in the number of persons who are detected in each of the divided areas in the captured image at every predetermined time. The person detection distribution and the information indicating the temporal change in the person detection distribution are transmitted to the purpose estimation unit 404.

The purpose estimation unit 404 estimates a purpose (or an intention) of an action taken by the person existing in the image captured by the image capturing unit 4001 based on an action recognition result (the person detection distribution and the information indicating the temporal change in the person detection distribution) received from the action recognition unit 403. In this regard, the purpose of the action estimated by the purpose estimation unit 404 is a purpose of a movement of the person. According to the present exemplary embodiment, an example in which the purpose of the action is estimated from the person detection distribution and the information indicating the temporal change in the person detection distribution is described. However, the purpose of the action may be estimated only from the information indicating the temporal change in the person detection distribution, for example. In addition, the purpose estimation unit 404 may receive only the person detection distribution from the action recognition unit 403, determine a temporal change in the person detection distribution, and then estimate the purpose of the action of the person therefrom.

The purpose estimation unit 404 determines whether the latest person detection distribution and the temporal change in the person detection distribution at that time which are received from the action recognition unit 403 include a specific pattern as described below. If it is determined that the specific pattern is included, the purpose estimation unit 404 estimates a purpose corresponding to the specific pattern.

An example of the specific pattern is a pattern of change in the person detection distribution, that is “a spatial area from which a person is not detected suddenly appears”. For example, if a lot of people come and go a concourse and a photographing screen of the image capturing unit 4001 capturing an image of the concourse is filled with a lot of people. At such time, if the number of persons detected from a certain spatial area suddenly decreases and then no one is detected therefrom for a certain period of time or more. In such a case, the person detection distribution that the purpose estimation unit 404 receives from the action recognition unit 403 changes from a state in which the numbers of detected persons are distributed throughout the screen to a state in which the number of detected persons changes into a negative direction only in a certain spatial area and persons are continuously detected from areas other than the spatial area. Instead of person detection, moving body (moving object) detection may be performed so as to detect a state that a spatial area from which a moving body is not detected suddenly appears. Person detection and moving body detection are examples of object detection.

In such a state, the purpose estimation unit 404 determines that a pattern of change, that is “a spatial area from which a person is not detected suddenly appears” is generates. In addition, the purpose estimation unit 404 estimates that “avoidance of a certain place” is a purpose of a person in the captured image.

FIG. 5 illustrates this case. More specifically, in FIG. 5, since juice is spilt from a fallen bottle near the middle of the image capturing range, passersby skirt around there. From a time point when juice is spilt, suddenly any person is no longer detected around the juice. Therefore the purpose estimation unit 404 identifies the pattern of change in the person detection distribution, that is “any person is suddenly no longer detected from a certain spatial area”. Then, the purpose estimation unit 404 estimates that “avoidance of a certain place” is a purpose of the action of a person in the captured image.

As for another example of the specific pattern, there is a pattern, that is “a spatial area from which a person is not detected spreads from a certain place as a center”. This is a pattern of change in the person detection distribution which is observed in a case that fire occurs in some place and people around there get far away from the fire. If the purpose estimation unit 404 determines that a pattern, i.e. “a spatial area from which a person is not detected spreads from a certain place as a center” is generated, the purpose estimation unit 404 estimates that “avoidance of a certain place” is a purpose of an action taken by a person in the captured image. This estimation can be performed by moving body detection instead of person detection.

As for further another example of the specific pattern, there can be a pattern, that is “a doughnut-shaped spatial area from which a person is not detected moves”. This is a pattern of change in the person detection distribution which is observed in a case that people keep away from some suspicious person. If the purpose estimation unit 404 determines that a pattern, i.e. “a doughnut-shaped spatial area from which a person is not detected moves” is generated, the purpose estimation unit 404 estimates that “avoidance of a specific object (specific person)” is a purpose of an action taken by a person in the captured image. This estimation can also be performed by moving body detection instead of person detection.

As for yet another example of the specific pattern, there can be a pattern, that is “the number of persons detected in a certain spatial area suddenly increases compared with the surroundings”. If the purpose estimation unit 404 determines that a pattern, i.e. “the number of persons detected in a certain spatial area suddenly increases compared with the surroundings” is generated, the purpose estimation unit 404 estimates that “attention to a specific object (specific person)” is a purpose of an action taken by a person in the captured image. This is a pattern of change in the person detection distribution and a purpose of an action which are observed in a case that, for example, there is a person in need of help (an injured person or the like) in the place and people gather around there to help the injured person. This estimation can also be performed by moving body detection instead of person detection.

As described above, the purpose estimation unit 404 detects a pattern in which the person detection distribution is locally changed as the specific pattern and estimates a purpose corresponding to the specific pattern as a purpose of an action taken by a person in the captured image.

If it is determined that the specific pattern is generated based on the action recognition result (the latest person detection distribution and the information indicating the temporal change in the person detection distribution), the purpose estimation unit 404 transmits information about the action recognition result and the image captured by the image capturing unit 4001 to the observation target determination unit 405.

The observation target determination unit 405 receives the action recognition result (the person detection distribution and the information indicating the temporal change in the person detection distribution) and the image captured by the image capturing unit 4001 from the purpose estimation unit 404 and then determines an observation target. In other words, the observation target determination unit 405 determines a person, an object, or a spatial area to be particularly observed based on the person detection distribution and the information indicating the temporal change in the person detection distribution at that time on the image captured by the image capturing unit 4001 which are received from the purpose estimation unit 404.

For example, when the information about the action recognition result received from the purpose estimation unit 404 indicates a pattern, i.e. “a spatial area from which a person is not detected suddenly appears”, the observation target determination unit 405 determines “the spatial area from which a person is not detected” as an observation target to be particularly observed. “A spatial area from which a moving body is not detected” can be determined as the observation target to be particularly observed instead of “a spatial area from which a person is not detected”. The same shall apply hereafter.

Further, when the information about the action recognition result received from the purpose estimation unit 404 indicates a pattern, i.e. “a spatial area from which a person is not detected spreads from a certain place as a center”, the observation target determination unit 405 determines “the spatial area from which a person is not detected” as the observation target to be particularly observed.

Furthermore, when the information about the action recognition result received from the purpose estimation unit 404 indicates a pattern, i.e. “a doughnut-shaped spatial area from which a person is not detected moves”, the observation target determination unit 405 determines “a center of the doughnut” as the observation target to be particularly observed.

Moreover, when the information about the action recognition result received from the purpose estimation unit 404 indicates a pattern, i.e. “the number of persons detected in a certain spatial area suddenly increases compared with the surroundings”, the observation target determination unit 405 determines “the spatial area the number of persons detected from which suddenly increases” as the observation target to be particularly observed.

In other words, the observation target determination unit 405 stores a determination method of an observation target as an established rule therein with respect to each specific pattern indicated by the action recognition result (the person detection distribution and the information indicating the temporal change in the person detection distribution) received from the purpose estimation unit 404 and determines the observation target tracking the determination method.

If the observation target determination unit 405 determines the observation target, position information indicating a position of the observation target in the image captured by the image capturing unit 4001 is transmitted from the observation target determination unit 405 to the observation target recognition unit 4002.

The observation target recognition unit 4002 performs observation processing with respect to the captured image received from the image capturing unit 4001. The observation processing targets on a spatial area, a person, and an object in the captured image indicated by the position information received from the observation target determination unit 405.

The observation processing performed by the observation target recognition unit 4002 on an image area in which the observation target exists includes, for example when an area is determined in the captured image, recognition processing for specifying an object existing in the area. In the example illustrated in FIG. 5, the observation target recognition unit 4002 recognizes “a fallen bottle and spilt liquid (juice)”. In addition to that, the observation target recognition unit 4002 can perform tracking processing for tracking a position of a person or an object determined as the observation target in the captured image. In this case, a frame is displayed around the person or the object as the observation target, and the frame is moved along with movement of the person or the object.

Further, the observation target recognition unit 4002 can perform, as examples of the observation processing, processing for recognizing a posture, a motion, and a facial expression if the observation target is a person. Furthermore, the observation target recognition unit 4002 may recognize, as an example of the observation processing, a degree of suspiciousness of a person as the observation target using recognition results of the posture, motion, facial expression, and others of the person as the observation target. However, the observation processing performed by the observation target recognition unit 4002 is not limited to the above-described examples. Moreover, a plurality of types of the observation processing (for example, the tracking processing and the facial expression recognition processing) may be performed on a single observation target.

The observation target recognition unit 4002 can also perform control of panning, tilting, and zooming on the image capturing unit 4001 according to a purpose of an action taken by a person. For example, panning and tilting are performed so as to bring the observation target to the center of the captured image. Further, for example, when an area from which a person is not detected suddenly appears, a zoom magnification may be controlled to enlarge the area for observation, and when an area from which a person is not detected spreads, the zoom magnification may be lowered for easier confirmation of the surroundings. As described above, the observation target recognition unit 4002 can change an image capturing range of the image capturing unit 4001 according to the recognized specific pattern and the determined observation target. In addition, the observation target recognition unit 4002 can control an image capturing unit, which performs image capturing in a narrow range, to capture an image in the narrow range of an observation target which is determined from an image captured by the image capturing unit 4001 which performs image capturing in a wide range.

The recognition result of the observation target recognition unit 4002 and the information indicating the position where the recognition is made are transmitted to the video display unit 4003 together with the image captured by the image capturing unit 4001.

The video display unit 4003 receives the image captured by the image capturing unit 4001 from the observation target recognition unit 4002 and displays the received image. The video display unit 4003 also receives an observation condition, an observation result, and information about a position of the observation target from the observation target recognition unit 4002 and visualizes and displays information about the observation condition and the observation result using the received information. For example, the video display unit 4003 superimposes a display indicating the observation result by observation target recognition unit 4002 on the image captured by the image capturing unit 4001.

In FIG. 5, a fallen bottle and spilt juice are encircled by in a dotted line. This is an example visualizing that a spatial area where the passersby 501, 502, and 503 skirt around is determined as the observation target by the observation target determination unit 405 and the observation processing is performed on the position.

However, the visualization method of an observation condition and an observation result is not limited to the above-described examples. For example, a text indicating an observation condition or an observation result by the observation target recognition unit 4002 may be displayed in a display area different from the display area of the image captured by the image capturing unit 4001. Further, for example, an image extracting an area of the observation target can be displayed together with texts indicating the observation condition and the observation result in a display area different from the display area of the captured image. The video display unit 4003 can display a text or a mark indicating that the recognition of the observation target is in processing. Further, if the specific pattern (for example, a pattern of “the number of persons detected in a certain spatial area suddenly increases compared with the surroundings”) is detected in the middle of the observation processing, the video display unit 4003 can display a fact that the specific pattern is detected on the screen before the observation processing (for example, the recognition processing) on the area is completed. However, the image display method by the video display unit 4003 is not limited to the above-described examples.

### (Processing)

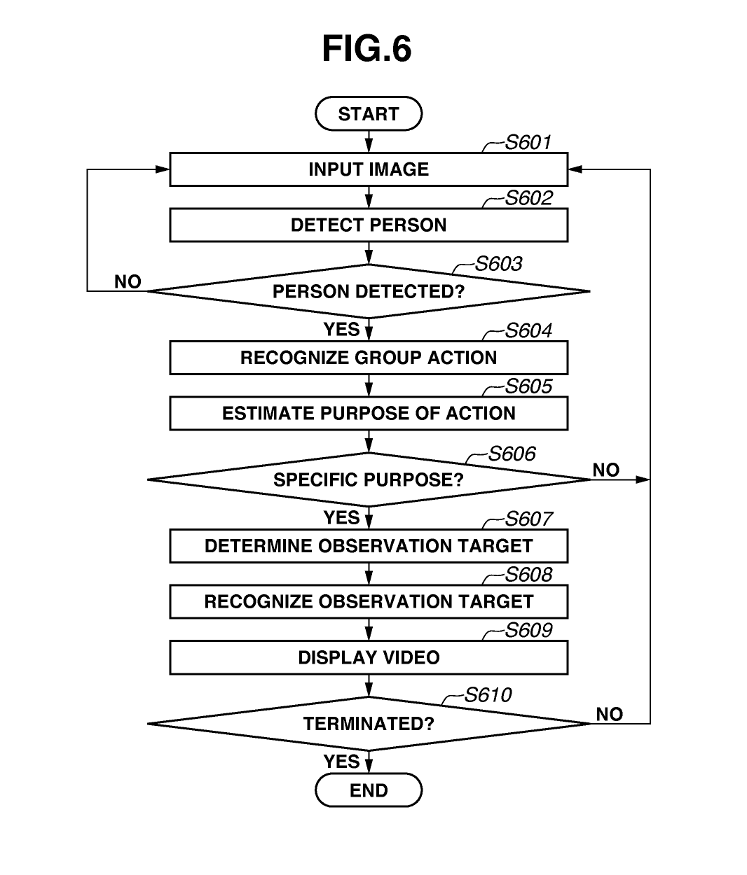

Next, processing performed by the monitoring system 4000 including the image processing apparatus 400 according to the present exemplary embodiment is described using a flowchart illustrated in FIG. 6. A CPU, which is not illustrated, reads out a program for executing the processing in FIG. 6 to a memory and executes the program, so that the image processing apparatus 400 according to the present exemplary embodiment can realize the processing illustrated in FIG. 6. Further, the image capturing unit 4001, the observation target recognition unit 4002, and the video display unit 4003 respectively includes CPUs, and each of the CPUs executes a program necessary for the respective apparatuses. However, a configuration of apparatuses in the monitoring system can be changed accordingly, for example, the observation target recognition unit 4002 and the video display unit 4003 are configured as an integrated apparatus, and processing performed in the observation target recognition unit 4002 and the video display unit 4003 are realized by the same CPU.

If a user starts up the monitoring system 4000 in a state that the image capturing unit 4001 is disposed in a space where a large number of unspecified persons come and go, such as an aisle in a shopping mall and a platform and a concourse of a station, first, the processing in step S601 is performed.

In step S601, the image capturing unit 4001 performs image capturing. If the image capturing unit 4001 includes a plurality of cameras, the plurality of cameras performs image capturing. All captured images are transmitted to the person detection unit 401 and the observation target recognition unit 4002. According to the present exemplary embodiment, an example in which all images captured by the image capturing unit 4001 are transmitted to the person detection unit 401 is mainly described, however, a frame rate of a captured image to be transmitted to the person detection unit 401 may be lower than a frame rate of the image capturing. For example, when the image capturing unit 4001 performs image capturing at 30 frames per second, a captured image with every other frame, namely 15 frames per second may be transmitted to the person detection unit 401. If the person detection unit 401 is input a captured image from the image capturing unit 4001, the processing proceeds to step S602.

In step S602, the person detection unit 401 performs processing for detecting an area in which a person is captured in the image received from the image capturing unit 4001. When the person detection unit 401 finishes the person detection processing, the processing proceeds to step S603.

In step S603, it is confirmed whether the person detection unit 401 detects a person in the image received from the image capturing unit 4001. If a person is not detected (NO in step S603), the processing returns to step S601. If a person is detected (YES in step S603), the person detection unit 401 generates information for specifying an image area in which the person is detected and transmits the information to the action recognition unit 403 together with the image captured by the image capturing unit 4001. If a plurality of persons is detected, the person detection unit 401 generates information pieces each for specifying an image area of each detected person and transmits the information pieces to the action recognition unit 403. If the person detection unit 401 transmits the information for specifying a position of the person to the action recognition unit 403, the processing proceeds to step S604.

In step S604, the action recognition unit 403 recognizes an action of the person using the information for specifying the image area in which the person is detected. The action recognition unit 403 first generates person detection distribution on the image captured by the image capturing unit 4001 and stores the person detection distribution therein. In other words, the action recognition unit 403 generates information indicating that how many persons are detected in each of predetermined divided areas in a captured image. For example, when an image capturing range of the image capturing unit 4001 is divided into nine by nine, namely 81 areas, the action recognition unit 403 generates the person detection distribution which indicate how many persons are detected in each of 81 areas. However, a division size of a captured image is not limited to nine by nine, and it may be larger or smaller. A user can arbitrarily set the division size. In addition, if it is determined that the division size set by a user is large (for example 90 by 90) and the processing will take too long time, the action recognition unit 403 can prompt the user to change the division size by displaying a warning or automatically change the division size. Further, if there is a person who exists across a plurality of areas, the action recognition unit 403 according to the present exemplary embodiment determines a center of the person and further determines that the person exists in the area to which the center of the person belongs.

If the action recognition unit 403 has performed the processing in step S604 in the past, the action recognition unit 403 generates information indicating a temporal change in the person detection distribution by comparing the person detection distribution accumulated in the past with the latest person detection distribution. The temporal change in the person detection distribution is information indicating a temporal change in persons detected in each of predetermined divided areas in a captured image. The action recognition unit 403 counts a total value of detected amounts of persons in each divided area in the latest one minute.

For example, a case is described as an example below in which 100 persons are detected in a first divided area and 90 persons are detected in a second divided area in the latest one minute (for example, from 13 o'clock to one minute past 13 o'clock). In this case, if 120 persons are detected in the first divided area and two persons are detected in the second divided area in the next one minute (from one minute past 13 o'clock to two minutes past 13 o'clock), the action recognition unit 403 generates information indicating a temporal change as follows.

More specifically, the action recognition unit 403 generates information indicating that plus 20 persons to the first divided area and minus 88 persons from the second divided area as information indicating the temporal change at the time of two minutes past 13 o'clock. For example, if the captured image is divided into 81 areas, the action recognition unit 403 according to the present exemplary embodiment generates information indicating a temporal change in each of 81 divided areas. However, information regarding a temporal change in the person detection distribution is not limited to the above-described example.

For example, the action recognition unit 403 can specify a moving path of each person detected by the person detection unit 401. In this case, the action recognition unit 403 can generate information indicating from which area to which area each person moves as information regarding a temporal change in the person detection distribution.

The action recognition unit 403 may perform moving body detection instead of person detection. The person detection and the moving body detection are examples of the object detection.

If the action recognition unit 403 transmits the latest person detection distribution and the information indicating the temporal change in the person detection distribution to the purpose estimation unit 404 as the action recognition result, the processing proceeds to step S605.

In step S605, the purpose estimation unit 404 estimates a purpose (or an intention) of an action taken by the person in the image captured by the image capturing unit 4001 based on the action recognition result (the person detection distribution and the information indicating the temporal change in the person detection distribution) received from the action recognition unit 403.

The purpose estimation unit 404 according to the present exemplary embodiment estimates a purpose of a movement or a purpose of selection of a moving path by the person as a purpose of an action.

The purpose estimation unit 404 first determines whether the specific pattern is included in the latest person detection distribution and the temporal change in the person detection distribution received from the action recognition unit 403. Then, if it is determined that the specific pattern is included therein, the purpose estimation unit 404 estimates a purpose corresponding to the specific pattern. If this estimation processing is performed by the purpose estimation unit 404, the processing proceeds to step S606.

In step S606, the purpose estimation unit 404 determines whether the purpose estimated by the purpose estimation unit 404 is a specific purpose which is determined in advance. If it is determined that the estimated purpose is the specific purpose (YES in step S606), the purpose estimation unit 404 transmits the action recognition result and the image captured by the image capturing unit 4001 received from the action recognition unit 403 to the observation target determination unit 405, and the processing proceeds to step S607. If the purpose of the action estimated by the purpose estimation unit 404 is not the specific purpose determined in advance (NO in step S606), the processing returns to step S601.

In step S607, the observation target determination unit 405 determines a person, an object, or an area to be an observation target from the image captured by the image capturing unit 4001 using the action recognition result and the image captured by the image capturing unit 4001. The action recognition result according to the present exemplary embodiment includes the person detection distribution and the information indicating the temporal change in the person detection distribution. In other words, the observation target determination unit 405 according to the present exemplary embodiment determines an observation target based on a movement (a change in an existing position) of the person detected by the person detection unit 401. In the example illustrated in FIG. 5, an object (juice) other than moving persons is determined as the observation target. In this regard, the observation target is not limited to an object and may be an area.

In other words, based on the person detection distribution and the information indicating the temporal change in the person detection distribution on the image captured by the image capturing unit 4001 which are received from the purpose estimation unit 404, the observation target determination unit 405 determines a person, an object, or an area to be particularly observed.

Further, if it is determined that a change occurs in a moving path of a person based on information regarding the moving path of the person, the observation target determination unit 405 according to the present exemplary embodiment can determine an area where any person no longer passes through because of the change as the observation target.

In the case where the area where any person no longer passes through is determined as the observation target, the observation target can be determined without estimating a purpose of an action taken by a person. In this case, the moving body detection can also be performed instead of the person detection.

If the observation target is determined, the observation target determination unit 405 transmits the information indicating a position of the observation target on the image captured by the image capturing unit 4001 to the observation target recognition unit 4002, and then the processing proceeds to step S608.

In step S608, the observation target recognition unit 4002 performs the observation processing with respect to the captured image received from the image capturing unit 4001. The observation processing targets on a person, an object, or an area in the captured image indicated by the information received from the observation target determination unit 405. Then, the observation target recognition unit 4002 transmits an observation processing result and information for specifying the position of the observation target on the captured image to the video display unit 4003 together with the image captured by the image capturing unit 4001. When the observation processing result and the captured image are transmitted to the video display unit 4003, the processing proceeds to step S609.

In step S609, the video display unit 4003 receives the image captured by the image capturing unit 4001 from the observation target recognition unit 4002 and displays the received image. The video display unit 4003 receives the observation processing result together with the information indicating the position of the observation target on the captured image from the observation target recognition unit 4002 and performs display corresponding to the information.

The video display unit 4003 may display a dotted line encircling the observation target therein or superimpose an arrow pointing the observation target on the captured image, for example. However, not limited to the display described above, the video display unit 4003 can perform display for emphasizing the observation target so as to enable a user who views the captured image to easily specify the observation target. Further, the video display unit 4003 can display observation results of the observation target (for example, a time length that the observation target stayed in the image, a recognition result of the observation target, and a direction of motion of the observation target) by a text, an icon, or the like in an area different from the display area of the image captured by the image capturing unit 4001. When the video display unit 4003 finishes the display, the processing proceeds to step S610. In step S610, it is confirmed whether the processing of the monitoring system 1000 will be terminated or not. If no, the processing returns to step S601. If yes, the processing is terminated.

According to the above-described processing, the image processing apparatus 400 can set an area in which the person detection distribution in the image captured by the image capturing unit 4001 is locally changed or a person who is included in such an area as a recognition target of the observation target recognition unit 4002. For example, if people who come and go in a station skirt around spilt juice or gather around an injured person to help him or her, the image processing apparatus 400 can set the “spilt juice” or the “injured person”, which is a reason for the people to take the action, as an observation target. The present invention makes use of a fact that a bias of the person detection distribution which is generated by a reasonable action taken by persons coming and going in a space captured by the image capturing unit 4001 indicates a target to be particularly recognized.

According to a third exemplary embodiment, an example is described in which a monitoring system is applied in a space where a large number of unspecified persons and a small number of specified persons who do some response to the large number of unspecified persons exist, such as a shop, a waiting room in a hospital or in a bank, and a ticket gate and a platform at a station. The monitoring system according to the present exemplary embodiment which includes an image capturing unit, an observation target recognition unit, a video display unit, and an image processing apparatus recognizes an observation target determined by the image processing apparatus through image processing, and captures and displays an image of the observation target.

### (Configuration)

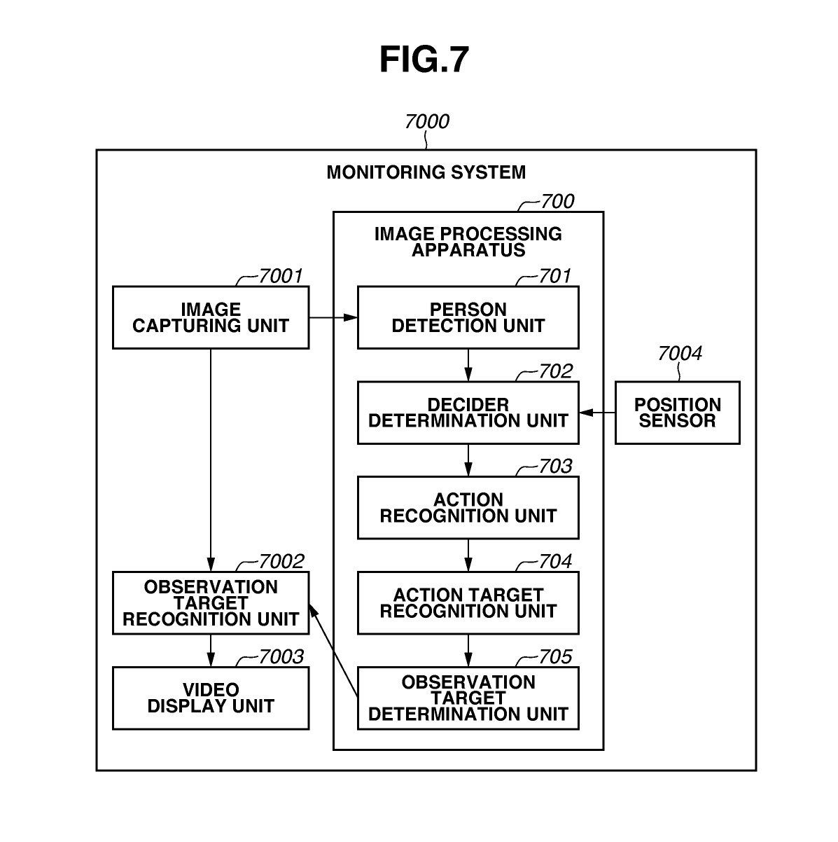

FIG. 7 illustrates a configuration of a monitoring system 7000 including an image processing apparatus 700 according to the present exemplary embodiment. The image processing apparatus 700 includes a person detection unit 701, a decider determination unit 702, an action recognition unit 703, the action target recognition unit 704, and the observation target determination unit 705. The monitoring system 7000 further includes an image capturing unit 7001, an observation target recognition unit 7002, a video display unit 7003, and the image processing apparatus 700. In addition, the image processing apparatus 700 may be integrated with any one or a plurality of the image capturing unit 7001, the observation target recognition unit 7002, and the video display unit 7003. The monitoring system 7000 may include a position sensor 7004.

The image capturing unit 7001 is an infrared camera referred to as a night vision camera which captures an image of a space and includes a light emitting infrared light to an image capturing direction. According to the present exemplary embodiment, an example is described in which the image capturing unit 7001 captures an image in a hospital waiting room at night. In other words, the image capturing unit 7001 is a camera which can capture the look even in a hospital waiting room at night in which light is often dimmed. However, a place where the image capturing unit 7001 is installed is not limited to a hospital at night. Further, the monitoring system according to the present exemplary embodiment can be applied to a bright place.

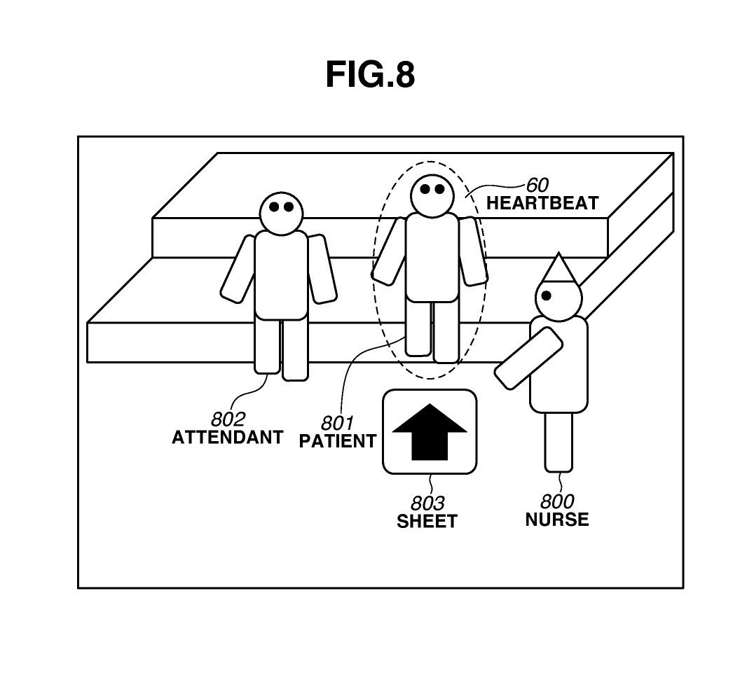

FIG. 8 schematically illustrates an example of an image captured by the image capturing unit 7001. FIG. 8 indicates presence of a patient 801 visiting a hospital in emergency and his/her attendant 802, who are regarded as a large number of unspecified persons appearing in a hospital waiting room at night. In addition, FIG. 8 indicates presence of a nurse 800 with a triangular cap taking care of a patient, who is regarded as a small number of specified persons appearing in the hospital. FIG. 8 further illustrates a scene that the nurse 800 places a sheet 803 in front of the patient 801 with an arrow drawn on the sheet facing to the patient 801. The arrow on the sheet 803 is painted with an infrared light reflection coating material, so that the arrow can be clearly captured on an image taken by the image capturing unit 7001 as the infrared camera.

The image captured by the image capturing unit 7001 is transmitted to the person detection unit 701 and the observation target recognition unit 7002.

The person detection unit 701 inputs the image captured by the image capturing unit 7001 thereto and also detects a person in the captured image. Detection of a person can be realized by detecting image features regarding a person from an image captured by the image capturing unit 7001. A method for detecting a person is similar to the person detection method performed by the person detection unit 101 according to the first exemplary embodiment, and thus detail descriptions thereof are omitted. In the example illustrated in FIG. 8, the nurse 800, the patient 801, and the attendant 802 are detected.

If a person is detected, the person detection unit 701 generates information for specifying an image area in which the person is detected and transmits the generated information to the decider determination unit 702 together with the image captured by the image capturing unit 7001. If a plurality of persons is detected from one image, the person detection unit 701 transmits information pieces each for specifying an image area of each detected person to the decider determination unit.

The decider determination unit 702 determines a person (decider) who decides an observation target from among the persons detected by the person detection unit 701. According to the present exemplary embodiment, a decider is a small number of specified persons (for example, a nurse and a doctor) who do some response to a large number of unspecified persons (for example, a patient and an attendant) appearing in a space where the image capturing unit 1001 captures images thereof. In FIG. 8, the nurse 800 is a person (decider) who decides an observation target.

A method for determining a small number of specified deciders (i.e., the nurse 800 according to the present exemplary embodiment) from among persons detected by the person detection unit 701 is similar to the determination method performed by the decider determination unit 102 according to the first exemplary embodiment, and thus detail descriptions thereof are omitted. However, a decider may be effectively specified in a dark place by causing a nurse or a doctor to wear clothes or a hat coated with an infrared light reflection coating material. In addition, when a person to be a decider wears clothes or a hat coated with an infrared light reflection coating material, person detection processing by the person detection unit 701 can be omitted in some cases.

The decider determination unit 702 may determine one person as a decider or a plurality of persons as the deciders. Further, the decider determination unit 702 may not determine any person as a decider in some cases.

The decider determination unit 702 transmits information for specifying an image area of the determined decider and the image captured by the image capturing unit 7001 to the action recognition unit 703.

The action recognition unit 703 recognizes an action of the decider based on the captured image and the information for specifying the image area of the decider received from the decider determination unit 702. According to the present exemplary embodiment, recognition of the action is to obtain information indicating a change in postures.

Thus, the action recognition unit 703 first recognizes a posture of the person (the decider) based on the information for specifying a position of the decider received from the decider determination unit 702. A specific method thereof is similar to the recognition method of postures performed by the action recognition unit 103 according to the first exemplary embodiment, and thus detail descriptions thereof are omitted. In the example illustrated in FIG. 8, a posture change, that is “placing an object by hand” is recognized. The action recognition unit 703 transmits an action recognition result to the action target recognition unit 704. The action recognition result includes information for specifying an action of the decider (for example, “placing an object”) and information regarding a positional relationship of human body parts related to the action (for example, “information regarding a direction of an arm placing the object”).

The action recognition result generated by the action recognition unit 703 is transmitted to the action target recognition unit 704 together with the image captured by the image capturing unit 7001.

If the action target recognition unit 704 receives a specific action recognition result from the action recognition unit 703, the action target recognition unit 704 performs observation processing on an object which is a target of the action corresponding to the received action recognition result.

A specific action recognition result is an action recognition result which indicates a posture change, that is “placing an object” according to the present exemplary embodiment. When receiving the action recognition result indicating the posture change of “placing an object” from the action recognition unit 703, the action target recognition unit 704 performs recognition processing of the “object” which is a target of the action (the posture change), namely “placing”.

The action target recognition unit 704 according to the present exemplary embodiment uses a technique for identifying an object for the recognition processing of the object. More specifically, the action target recognition unit 704 stores several “object” image patterns in advance. Then, if an action recognition result corresponding to “placing an object” is received from the action recognition unit 703, the action target recognition unit 704 detects the object placed by the decider using the information regarding the positional relationship of the human body parts of the decider included in the action recognition result and the image patterns stored in advance. The action target recognition unit 704 may also detect the object using either one of the information regarding the positional relationship of the human body parts and the image patterns stored in advance. The object thus detected is recognized by the action target recognition unit 704 as an action target.

Several “image patterns” to be stored in advance include an image pattern of an object indicating a certain direction, for example, a plate on which an arrow is drawn. In the example illustrated in FIG. 8, the sheet 803 on which an arrow is drawn is recognized. Such an object indicating a direction is an example of an object to be detected.

When recognizing an object indicating a direction in the periphery of the decider, the action target recognition unit 704 transmits information regarding a position on the captured image where the object is detected and the image captured by the image capturing unit 7001 to the observation target determination unit 705.

The observation target determination unit 705 determines an observation target using position information indicating the position on the captured image of the object (the object indicating a direction) which is detected by the action target recognition unit 704 and the image captured by the image capturing unit 7001. More specifically, the observation target determination unit 705 determines a person or an object which exists in a direction indicated by the object indicating a direction on the image captured by the image capturing unit 7001 as an observation target.

In the example illustrated in FIG. 8, the patient 801 who is indicated by the sheet 803 on which an arrow is drawn as the observation target.

When the observation target is determined, the observation target determination unit 705 transmits the information indicating the position of the observation target on the captured image to the observation target recognition unit 7002.

If the observation target determination unit 705 cannot detect a person or an object in the direction indicated by the object indicating a direction (i.e., the sheet 803), the observation target determination unit 705 transmits information indicating that an observation target is not yet determined to the observation target recognition unit 7002. Further, the observation target determination unit 705 can search an observation target as necessary by changing an image capturing range of the image capturing unit 7001 with use of panning, tilting, zooming, and the like.

The observation target recognition unit 7002 performs observation processing with respect to the captured image received from the image capturing unit 7001. The observation processing targets on a person and an object corresponding to the position information of the observation target received from the observation target determination unit 705. The observation processing according to the present exemplary embodiment includes tracking processing and recognition processing of the observation target and processing which extracts and records an image of the observation target in high resolution. The observation target recognition unit 7002 performs the observation processing with respect to the same observation target until the information regarding the position of the observation target is newly received from the observation target determination unit 705. Therefore, the observation target recognition unit 7002 stores information for identifying the observation target therein. However, as described in the first exemplary embodiment, maintaining and switching on the observation target are not limited to the above-described examples.

The information for identifying the observation target includes the information indicating the position of the observation target on the captured image and feature amounts regarding an appearance of the observation target, such as a color and a shape. The observation target determination unit 705 updates the information indicating the position of the observation target each time the observation target is determined (every predetermined period of time). More specifically, the observation target determination unit 705 determines a position of the observation target from a captured image (a first captured image) of the image capturing unit 7001. Then, when a next captured image (a second captured image) is obtained, the observation target determination unit 705 detects the observation target from the second captured image. If the position of the observation target in the first captured image is somewhat different from the position of the observation target in the second captured image by the movement of the observation target, the observation target determination unit 705 can detect the observation target in the second captured image using the information about the feature amount of the observation target. Further, when determining the observation target from the second captured image, the observation target determination unit 705 stores the position of the observation target in the second captured image and the feature amount of the observation target and uses them to detect the observation target in a next third captured image.

When the observation target recognition unit 7002 does not receive information regarding the observation target from the observation target determination unit 705 and not store the information for identifying the observation target therein, the observation target recognition unit 7002 does not perform the observation processing.

The observation processing that the observation target recognition unit 7002 performs on an image area of the observation target includes, for example, processing (tracking processing) for tracking a position of the observation target in the captured image. Further, the observation target recognition unit 7002 can perform identification processing of the observation target as the observation processing. The identification processing is processing for identifying a posture (for example, squatting and lying) of an observation target, when the observation target is a person. The observation target recognition unit 7002 can also identify age, sex, individual, and facial expression of an observation target person, as the identification processing.

For example, if a patient in a hospital waiting room at night is an observation target, the observation target recognition unit 7002 may identify vital signs (heart rate and body temperature) of the patient as the observation target based on an image captured by the image capturing unit 7001. According to this technique, if patient's condition suddenly changes while he or she is kept waiting because of preparation of treatment or the like, the monitoring system 7000 can recognize the sudden change and inform the nurse 800 of it. A method for recognizing a vital sign of a person based on an image captured by a camera is known in a non-patent literature No. 1 or the like.
<Non-patent literature No. 1> Poh, M. Z., McDuff, D. J., Picard, R. W., “A Medical Mirror For Non-Contact Health Monitoring,” ACM SIGGRAPH Emerging Technologies, August 2011.

A recognition result by the observation target recognition unit 7002 and information indicating a position on the image on which the recognition is made are transmitted to the video display unit 7003 together with the captured image received from the image capturing unit 7001.

The video display unit 7003 receives the image captured by the image capturing unit 7001 from the observation target recognition unit 7002 and displays the received image. The video display unit 7003 also receives the recognition result and the information indicating the position on the image on which the recognition is made from the observation target recognition unit 7002 and visualizes and displays the received information.

For example, the video display unit 7003 superimposes the display indicating the recognition result received from the observation target recognition unit 7002 on the image captured by the image capturing unit 7001. In FIG. 8, the patient 801 is encircled in a dotted line. This is an example visualizing that the patient 801 is determined as the observation target by the observation target determination unit 705, and the observation processing is performed by the observation target recognition unit 7002. Further, FIG. 8 indicates that a text “heartbeat 60” indicating a recognition result by the observation target recognition unit 7002 is displayed next to the patient 801 by superimposing thereon.

However, the visualization method is not limited to the above-described example. For example, the video display unit 7003 may display a text or an icon indicating the recognition result by the observation target recognition unit 7002 and an area of the captured image in which the recognition result is obtained by extracting the area in an area different from a display area of the captured image received from the image capturing unit 7001.

Since the video display unit 7003 displays the recognition result of the observation target recognition unit 7002, a user can easily confirm that which target is set as the observation target by the image processing apparatus 700.

### (Processing)

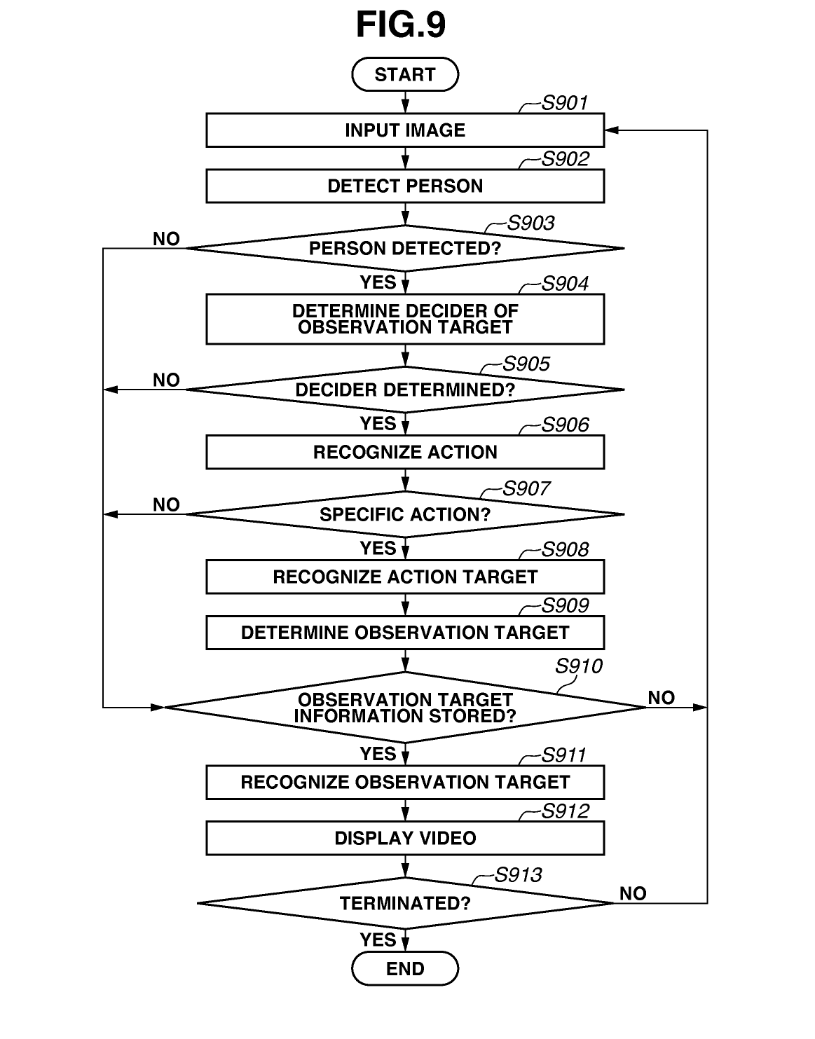

Next, processing performed by the monitoring system 7000 including the image processing apparatus 700 according to the present exemplary embodiment is described using a flowchart illustrated in FIG. 9. A CPU, which is not illustrated, reads out a program for executing the processing in FIG. 9 to a memory and executes the program, so that the image processing apparatus 700 according to the present exemplary embodiment can realize the processing illustrated in FIG. 9. Further, the image capturing unit 7001, the observation target recognition unit 7002, and the video display unit 7003 respectively includes CPUs, and each of the CPUs executes a program necessary for the respective apparatuses. However, a configuration of apparatuses in the monitoring system can be changed accordingly, for example, the observation target recognition unit 7002 and the video display unit 7003 are configured as an integrated apparatus, and processing performed in the observation target recognition unit 7002 and the video display unit 7003 are realized by the same CPU.

If a user starts up the monitoring system 7000 in a state that the image capturing unit 7001 is disposed in a space such as a hospital waiting room or the like, first, the processing in step S901 is performed.

In step S901, the image capturing unit 7001 performs image capturing. If the image capturing unit 7001 includes a plurality of cameras, the plurality of cameras performs image capturing. All captured images are transmitted to the person detection unit 701 and the observation target recognition unit 7002. According to the present exemplary embodiment, an example in which all images captured by the image capturing unit 7001 are transmitted to the person detection unit 701 is mainly described, however, a frame rate of a captured image to be transmitted to the person detection unit 701 may be lower than a frame rate of the image capturing. For example, when the image capturing unit 7001 performs image capturing at 30 frames per second, a captured image with every other frame, namely 15 frames per second may be transmitted to the person detection unit 701. If the person detection unit 701 is input a captured image from the image capturing unit 7001, the processing proceeds to step S902.

In step S902, the person detection unit 701 performs processing for detecting an area in which a person is captured in the image received from the image capturing unit 7001. When the person detection unit 701 finishes the person detection processing, the processing proceeds to step S903.

In step S903, it is confirmed whether the person detection unit 701 detects a person in the image received from the image capturing unit 7001. If a person is not detected (NO in step S903), the processing proceeds to step S910. If a person is detected (YES in step S903), the person detection unit 701 generates information for specifying an image area in which the person is detected and transmits the information to the decider determination unit 702 together with the image captured by the image capturing unit 7001. If a plurality of persons is detected, the person detection unit 701 generates information pieces each for specifying an image area of each detected person and transmits the information pieces to the decider determination unit 702. When the person detection unit 101 transmits the information for specifying the position of the person to the decider determination unit 102, the processing proceeds to step S904.

In step S904, the decider determination unit 702 determines a person (a decider) who decides an observation target. The decider determination unit 702 according to the present exemplary embodiment determines a small number of specified persons (a nurse and a doctor) who do some response to a large number of unspecified persons (a patient and an attendant) existing especially in the image captured by the image capturing unit 7001 as the decider. In the example illustrated in FIG. 8, the nurse 800 is determined as the decider. Further, if a person to be a decider (a nurse and a doctor) wears clothes or a hat coated with an infrared light reflection coating material, the decider determination unit 702 can more effectively determine the decider.

When the processing for determining the decider is performed, the processing proceeds to step S905.

In step S905, it is confirmed whether the decider of the observation target is determined from among the persons detected by the person detection unit 701. If the decider is not determined (NO in step S905), the processing proceeds to step S910. If the decider is determined (YES in step S905), the decider determination unit 702 transmits the position information for specifying an image area of the decider and the captured image to the action recognition unit 703. Then, the processing proceeds to step S906.

In step S906, the action recognition unit 703 receives the position information of the decider together with the image captured by the image capturing unit 7001 and recognizes a posture change (action) of the decider. According to the present exemplary embodiment, recognition of the action is to obtain information indicating a change in postures. In the example illustrated in FIG. 8, a posture change, that is “placing an object by hand” is recognized by the action recognition unit 703. The action recognition result is transmitted to the action target recognition unit 704 together with the image captured by the image capturing unit 7001. Then, the processing proceeds to step S907.

In step S907, the action target recognition unit 704 determines whether the action recognition result received from the action recognition unit 703 is a specific action recognition result or not. A specific action recognition result is an action recognition result which indicates a posture change, that is “placing an object” according to the present exemplary embodiment. If the action recognition result received from the action recognition unit 703 is not the specific action recognition result (NO in step S907), the processing proceeds to step S910. If the action recognition result received from the action recognition unit 703 is the specific action recognition result (YES in step S907), the processing proceeds to step S908.

In step S908, the action target recognition unit 704 recognizes an object to be a target of an action indicated by the specific action recognition result received from the action recognition unit 703. The specific action recognition result according to the present exemplary embodiment is a recognition result indicating a posture change of “placing an object”. The action target recognition unit 704 recognizes an “object” which is a target of the action, that is “placing”. Further, an “object” according to the present exemplary embodiment is an object indicating a certain direction, for example, a plate on which an arrow is drawn. In the example illustrated in FIG. 8, the sheet 803 on which an arrow is drawn is recognized by the action target recognition unit 704. The sheet 803 is an example of an object to be detected. If such an object indicating a direction is recognized, the action target recognition unit 704 transmits information indicating a position of the object (the sheet 803) on the captured image and the image captured by the image capturing unit 7001 to the observation target determination unit 705. Then, the processing proceeds to step S909.

In step S909, the observation target determination unit 705 determines an observation target from among persons, objects, and areas in the image captured by the image capturing unit 7001. In other words, the observation target determination unit 705 determines an observation target in the image input by the person detection unit 701 according to the object (the sheet 803) detected by the action target recognition unit 704. More specifically, the observation target determination unit 705 determines a person or an object which exists in a direction indicated by the object indicating a direction (the sheet 803) as the observation target in the image captured by the image capturing unit 7001. In the example illustrated in FIG. 8, the patient 801 indicated by the sheet 803 on which an arrow is drawn is determined as the observation target. If the observation target is determined, the observation target determination unit 705 transmits information indicating a position of the observation target (the patient 801) on the image captured by the image capturing unit 7001 and information regarding an appearance of the observation target to the observation target recognition unit 7002 as information for identifying the observation target. The information regarding an appearance of the observation target is information regarding, for example, a color, a shape, and a posture of the observation target.

If a person or an object is not detected in the direction indicated by the object indicating a direction (the sheet 803), the observation target determination unit 705 transmits information indicating that an observation target is not yet determined to the observation target recognition unit 7002. Further, if the observation target recognition unit 7002 cannot detect a person or an object in the direction indicated by the object indicating a direction (the sheet 803), the observation target recognition unit 7002 may detect the observation target as necessary by changing an image capturing range of the image capturing unit 7001 by control of panning, tilting, zooming, and the like. Then, the processing proceeds to step S910.

In step S910, it is determined whether the observation target recognition unit 7002 stores the information for identifying the observation target. If the observation target recognition unit 7002 according to the present exemplary embodiment does not store the information for identifying the observation target (NO in step S910), the processing returns to step S901. If the information for identifying the observation target is stored (YES in step 910), the processing proceeds to step S911.

In step S911, the observation target recognition unit 7002 executes the observation processing of the observation target. The observation processing according to the present exemplary embodiment is processing for recognizing, for example, vital signs of the person as the observation target based on the image captured by the image capturing unit 7001. Further, as for another example of the observation processing, tracking processing, facial expression recognition processing, and posture change recognition processing of the observation target (the patient 801), and processing for extracting an area of the observation target in high resolution may be executed according to brightness of the captured image or the like. The recognition result by the observation target recognition unit 7002 and the information indicating the position of the observation target on the captured image are transmitted to the video display unit 7003 together with the image captured by the image capturing unit 7001. Then, the processing proceeds to step S912.

In step S912, the video display unit 7003 receives the image captured by the image capturing unit 7001 from the observation target recognition unit 7002 and displays the received image. The video display unit 7003 also receives the information regarding the position of the observation target and the information indicating the result of the observation processing from the observation target recognition unit 7002 and performs display corresponding to the received information pieces. The video display unit 7003 can display, for example, vital signs of the observation target near the observation target (the patient 801). In addition, the video display unit 7003 may display, for example, a dotted line encircling the observation target (the patient 801) or an arrow pointing the observation target by superimposing on the captured image. However, display is not limited to these examples. Further, the video display unit 7003 can display an observation result of the observation target (for example, vital signs of the patient 801) by a text or an icon in an area different from the display area of the captured image of the image capturing unit 7001. When the video display unit 7003 finishes the display, the processing proceeds to step S913. In step S913, it is confirmed whether the processing of the monitoring system 1000 will be terminated or not. If no, the processing returns to step S901. If yes, the processing is terminated.

According to the above-described processing, the image processing apparatus 700 can set a person or an object (the patient 801) to be a target of a specific action using an object (the sheet 803) taken by a specific person (the nurse 800) in the image captured by the image capturing unit 7001 as a recognition target of the observation target recognition unit 1002. In the example according to the present exemplary embodiment, if the nurse 800 indicates the patient 801 waiting for an examination using a specific object (the sheet 803) in a hospital waiting room at night, after that, the observation target recognition unit 7002 continues to recognize the vital signs of the patient 801. The image processing apparatus 700 determines the observation target according to whether the specific action is taken by the specific person, so that if a person, for example, an attendant of the patient moves the specific object without permission, determination or change of the observation target is not performed. In other words, the observation target is not changed unintentionally.

Further, if a positional relationship between the observation target and the object indicating the observation target is changed because of a movement of the patient as the observation target, the change is not accompanied with the specific action taken by the specific person (the nurse 800), so that determination or change of the observation target is not performed. Accordingly, a target whose features normally used for personal identification, such as a facial color, facial expression, clothes, and posture, are difficult to be used for a various reasons like a patient waiting for an examination in a waiting room at night can be set as a target for the recognition processing by an action with respect to the specific object taken by the specific person, such as a nurse. There is no need to provide a special instruction to a person to be a recognition target, thus it can be said that the method according to the present exemplary embodiment is effective for a case when a patient felling ill or the like is a target.

The present invention can be also realized by executing processing described below. More specifically, software (a program) for realizing the functions of the above-described exemplary embodiments is supplied to a system or an apparatus via a network or various storage media, and a computer (or a CPU or a micro processing unit (MPU)) of the system or the apparatus reads and executes the program. In addition, the program may be supplied by storing in computer-readable storage media. Further, according to the computer of the apparatus, an instruction to execute processing may be input from an input unit, and a result of the instructed processing may be displayed by an output unit.

### Effects of Exemplary Embodiments

The image processing according to the first exemplary embodiment can set a person, an object, or a spatial area which is regarded as a target of a posture change as a recognition target based on the posture change (action) having a specific purpose taken by a specific person in a space where the image capturing unit captures images thereof. For example, one or a plurality of customers visiting a commercial facility can be set as a recognition target of a suspicious action, such as shoplifting, or an evaluation target of a degree of potential excellent customer by an action of a shop staff in the commercial facility, such as gazing at a person to be a recognition target or indicating the person by hand. The observation target is not limited to a person, and an object such as an item sold in the shop and an aisle where goods or the like pass through may be the observation target. In that case, the item can be regarded as a target of leaving detection and the aisle can be regarded as a spatial area in which item passage detection is performed. If an action natural in the circumstances, such as looking at something for a certain period of time is set as a specific action for setting an observation target, the observation target can be set without being noticed by persons in the surroundings including a customer to be set as the observation target.

The image processing apparatus according to the second exemplary embodiment can set an area in which person detection distribution is locally changed in a space where the image capturing unit captures images and a person who exists in such area as a recognition target. For example, if persons who come and go in a station skirt around spilt juice or gather around an injured person to help him or her, the “spilt juice” or the “injured person” which is a reason for the people to take the action can be set as an observation target to be particularly recognized. Accordingly, if each of persons coming and going in a space just acts reasonably, an appropriate target can be set as the observation target to be particularly recognized even there is no intention of setting the observation target particularly.

The image processing apparatus according to the third exemplary embodiment can set a person or an object to be a target of a specific action using an object taken by a specific person existing in a space to be captured as a recognition target of the observation target recognition unit. For example, if a nurse indicates a patient waiting for an examination using a specific object in a hospital waiting room at night, after that the patient can be set as a target of vital recognition or the like. An observation target is determined based on whether the specific action is taken by the specific person, so that if an unrelated person takes a similar action, determination or change of the observation target is not performed. In other words, the observation target is not changed unintentionally. In addition, if a positional relationship between the observation target and the object indicating the observation target is changed because of a movement of the patient as the observation target, the change is not accompanied with the specific action taken by the specific person (a nurse), so that determination or change of the observation target is not performed. Accordingly, a target whose features normally used for personal identification, such as a facial color, facial expression, clothes, and posture, are difficult to be used for a various reasons like a patient waiting for an examination in a waiting room at night can be set as a target for the recognition processing by an action with respect to the specific object taken by the specific person, such as a nurse. There is no need to provide a special instruction to a person to be a recognition target, thus it can be said that the method according to the present exemplary embodiment is effective for a case when a patient felling ill or the like is a target.

The image capturing unit according to the exemplary embodiments of the present invention may be any object as long as the object can capture an image of a real space. The image capturing unit may be a visible light camera, an infrared camera, and an ultraviolet camera. The number of cameras may be one or plural.

Further, the image processing apparatus according to the exemplary embodiments of the present invention may be any apparatus as long as the apparatus can set a person, an object, or an area as an observation target to be particularly recognized based on an action taken by a specific person existing in a space where the image capturing unit captures images thereof. The specific person described here may be a single person, a plurality of persons, and all persons existing in the space. The action taken by the specific person may be a posture change of the specific person, a moving pattern or existence distribution coming and going in a space, and an action using an object.

Further, the position sensor according to the exemplary embodiments of the present invention may be any object as long as the object can measure a position of a person who determines an observation target. The position sensor may be a position sensor like a global positioning system (GPS) and a touch sensor on a display unit for displaying a video capturing a person.

Furthermore, the observation target recognition unit according to the exemplary embodiments of the present invention may be any object as long as the object can recognize a person or an object set as an observation target. The observation target recognition unit may recognize a face, an action, a facial expression, and a vital sign value of a person set as the observation target. If an object is the observation target, the observation target recognition unit may recognize a moving path, individual identification information, a size, and a weight of the object.

Moreover, the video display unit according to the exemplary embodiments of the present invention may be any object as long as the object can display an image captured by the image capturing unit and a recognition result obtained by the observation target recognition unit according to the present exemplary embodiments.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the monitoring system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-176249, filed Aug. 28, 2013 which is hereby incorporated by reference herein in its entirety.

What is claimed is:

1. An image processing apparatus comprising:
an obtaining unit configured to obtain an image;
a detection unit configured to detect one or a plurality of persons from the obtained image; and
a determination unit configured to determine an observation target according to a predetermined action taken by the detected person from an area different from an area corresponding to the person who takes the predetermined action.

2. The image processing apparatus according to claim 1, wherein the determination unit specifies a content of the action based on at least one of a motion and a movement of the detected person.

3. The image processing apparatus according to claim 1, wherein the determination unit determines the observation target according to an action taken by a person who has a predetermined feature amount among the detected persons.

4. The image processing apparatus according to claim 1, wherein the determination unit determines the observation target according to an action taken by a person whose time length existing in the image is equal to or more than a predetermined time length among the detected persons.

5. The image processing apparatus according to claim 1, further comprising a sensor information obtaining unit configured to obtain information from a position sensor,
wherein the determination unit determines the observation target according to an action taken by a person corresponding to information from the position sensor among the detected persons.

6. The image processing apparatus according to claim 1, wherein the determination unit determines the observation target based on a change in an existing position of the detected person in the image.

7. The image processing apparatus according to claim 1, further comprising a specification unit configured to specify a moving path of the detected person from the image obtained by the obtaining unit,
wherein, in a case where a change occurs in a moving path of the person specified by the specification unit, the determination unit determines an area in which a person does no longer pass through due to the change as the observation target.

8. An image processing apparatus comprising:
an obtaining unit configured to obtain an image;
a detection unit configured to detect an object from the obtained image; and
a determination unit configured to determine an observation target according to the detected object from an area different from an area corresponding to the object.

9. The image processing apparatus according to claim 8, wherein the determination unit determines the observation target based on a change in an existing position of the detected object in the image.

10. The image processing apparatus according to claim 8, further comprising a specification unit configured to specify a moving path of the detected object from the image obtained by the obtaining unit,
wherein, in a case where a change occurs in a moving path of the object specified by the specification unit, the determination unit determines an area in which an object does no longer pass through due to the change as the observation target.

11. The image processing apparatus according to claim 8, wherein the determination unit determines a person who exists in a direction indicated by an arrow mark detected by the detection unit as the observation target.

12. The image processing apparatus according to claim 1, further comprising,
a recording unit configured to record an image obtained by the obtaining unit after determination of the observation target by the determination unit.

13. The image processing apparatus according to claim 1, further comprising,
a control unit configured to change an image capturing range of an image capturing unit which captures the image according to determination of the observation target by the determination unit.

14. The image processing apparatus according to claim 1, further comprising,
a control unit configured to control resolution so that resolution corresponding to an area of the observation target determined by the determination unit becomes higher than resolution before the determination.

15. A method for processing an image performed by an image processing apparatus, the method comprising:
inputting for obtaining an image;
detecting a person from the obtained image; and
determining an observation target according to a predetermined action taken by the detected person from an area different from an area corresponding to the person who takes the predetermined action.

16. The method according to claim 15, wherein
the observation target is determined according to an action taken by a person who has a predetermined feature amount among the detected persons.

17. The method according to claim 15, wherein the observation target is determined based on a change in an existing position of the detected person in the image.

18. A method for processing an image performed by an image processing apparatus, the method comprising:
obtaining an image;
detecting an object from the obtained image; and
determining the observation target according to the detected object from an area different from an area corresponding to the object.

19. The method according to claim 18, wherein
the observation target is determined based on a change in an existing position of the detected object in the image.

20. The method according to claim 18, further comprising specifying a moving path of the object detected from the obtained image,
wherein, in a case where a change occurs in a moving path of the specified object, an area in which an object does no longer pass through due to the change is determined as the observation target.

21. A computer-readable storage medium storing a computer-executable program, the program comprising:
obtaining an image;
detecting a person from the obtained image; and
determining an observation target according to a predetermined action taken by the detected person from an area different from an area corresponding to the person who takes the predetermined action.

22. A computer-readable storage medium storing a computer-executable program, the program comprising:
obtaining an image;
detecting an object from the obtained image; and
determining an observation target according to the detected object from an area different from an area corresponding to the object.
